(19) United States
(12) Patent Application Publication
(10) Pub. No.: US 2010/0265214 A1
(43) Pub. Date: Oct. 21, 2010

(54) WRITING TABLET INFORMATION RECORDING DEVICE

(75) Inventors: Albert Green, Kent, OH (US); Xiao-Yang Huang, Stow, OH (US); Tod L. Schneider, Kent, OH (US)

Correspondence Address: PEARNE & GORDON LLP, 1801 EAST 9TH STREET, SUITE 1200, CLEVELAND, OH, 44114-3108, US

(73) Assignee: KENT DISPLAYS INCORPORATED, Kent, OH (US)

(21) Appl. No.: 12/787,843

(22) Filed: May 26, 2010

Related U.S. Application Data
(63) Continuation-in-part of application No. 12/152,729, filed on May 16, 2008.
(60) Provisional application No. 60/962,625, filed on Jul. 31, 2007.
(60) Provisional application No. 61/181,716, filed on May 28, 2009.

(51) Int. Cl. G06F 3/038; G06F 3/045

(52) U.S. Cl. 345/174; 345/173; 345/87

(57) ABSTRACT

A writing/drawing tablet utilizing a data capture device such as a pressure sensitive display that can capture data from the resulting image drawn on the device. In general, Bistable Liquid Crystal Displays (BLCD), and in particular, Cholesteric Liquid Crystal Displays (ChLCDs), can be utilized in such a device to create low cost pressure sensitive displays that are efficient power consumers and that can be utilized in a number of unique devices.

### CROSS-REFERENCES TO RELATED APPLICATIONS

This application is a continuation-in-part of application Ser. No. 12/152,729, filed on May 16, 2008, which claims the benefit of U.S. provisional application Ser. No. 60/962,625 filed on Jul. 31, 2007, both incorporated herein by reference. This application also claims the benefit of U.S. provisional application Ser. No. 61/181,716 filed on May 28, 2009, and incorporated herein by reference.

### FIELD OF THE INVENTION

This application relates generally to a writing/drawing tablet utilizing a pressure sensitive display that can capture data from the resulting image. In general, Bistable Liquid Crystal Displays (BLCD), and in particular, Cholesteric Liquid Crystal Displays (ChLCDs), have proven to have great potential to create low cost pressure sensitive displays that are efficient power consumers and that can be utilized in a number of unique devices.

### BACKGROUND OF INVENTION

We are accustomed to writing, drawing or painting in different colors on paper, cloth, or other surfaces using crayons, paints, inks, colored chalk, or colored pencils to cite a few examples. Using more modern technology brought on by touch screens and powerful software, we can write on computer screens and make different color images. However, we have not had the privilege of a simple writing pad that imitates paper, devoid of complex electronics and software to hand write or draw images in a multitude of different colors with an untethered stylus such as a pencil or ink pen. Commercial devices such as the Etch A Sketch or the Magna Doodle have not offered multicolor capability.

A considerable improvement on writing pads was made with the discovery of bistable cholesteric liquid crystals (see U.S. Pat. No. 5,453,863) that could be switched by low voltage DC pulses by changing the magnitude of the pulse rather than the frequency. Furthermore, it was discovered that the pressure of a stylus could be used to write a planar line on a focal conic bistable cholesteric layer (see U.S. Pat. No. 6,104,448) that could then be erased with a low voltage DC pulse. There were found to be many other advantages of the bistable materials in that an image created on the writing pad display did not degrade with time and would last indefinitely until erased. The erasure time was found to be less than a second making the bistable cholesteric liquid crystal display a substantially more practical device for a writing pad but with limitations as will be described later.

Cholesteric liquid crystalline materials are unique in their optical and electro-optical features. They can be tailored to Bragg reflect light at a pre-selected wavelength and bandwidth, as these materials possess a helical structure in which the liquid crystal (LC) director twists around a helical axis. The reflected light is circularly polarized with the same handedness as the helical structure of the LC. If the incident light is not polarized, it will be decomposed into two circular polarized components with opposite handedness and one of the components reflected.

The cholesteric material is typically electrically switched to either one of two stable textures; planar or focal conic as described, for example in U.S. Pat. No. 5,453,863. In the planar texture, the director of the LC is uniformly parallel to the plane of the substrates across the cell but has a helical twist perpendicular to the plane of the substrates. It is the helical twist of the uniform planar texture that Bragg reflects light in a selected wavelength band. The focal conic texture contains defects that perturb the orientation of the liquid crystalline helices. In the typical focal conic texture, the defect density is high; thus the helical domain size becomes small and randomized in orientation such that it is just forward scattering and does not reflect impinging light. Once the defect structures are created, they are topologically stable and cannot be removed unless by some external force such as an electric field. Thus, the focal conic texture remains stable and forward scatters light of all wavelengths into an absorbing (usually black) background. These bistable structures can be electronically switched between each other at rapid rates (on the order of milliseconds). Gray scale is also available through various switching schemes in order to adjust the density of reflective helical domains that are oriented perpendicular to the substrates (planar texture) relative to the randomized forward scattering domains (focal conic texture).

Bistable cholesteric liquid crystal displays have several important electronic drive features that other bistable reflective technologies do not. Of extreme importance for addressing a matrix of many pixels in a display is the characteristic of a voltage threshold. A threshold is used for multiplexing a row/column matrix without the need of an expensive active matrix (transistor at each pixel). Bistability with a voltage threshold allows very high-resolution displays to be produced with low-cost passive matrix technology. Gray scale capability allows stacked red, green blue, high-resolution displays with full-color capability where as many as 4096 colors have been demonstrated.

In a cholesteric liquid crystal display, the liquid crystal is typically sandwiched between two substrates that are spaced to a particular gap. The substrates can be either glass or plastic. The bottom substrate is painted with a light absorbing (black or colored) back layer. The cell gap is usually set by plastic or glass spacers that are either cylindrical or spherical in shape. However, when one presses on the top substrate, the liquid crystal is displaced (since fluids are not very compressible) and induced to flow laterally out of the area. Of principle interest is that when the focal conic texture of the liquid crystal is induced to flow, the resulting texture is the planar state. The reflective planar state contrasts well with the dark focal conic background. This is a principle behind U.S. Pat. No. 6,104,448 “Pressure Sensitive Liquid Crystalline Light Modulating Device and Material” which discloses that application of a mechanical stress to the liquid crystalline light modulating material changes an initial light scattering focal conic texture to the light reflecting planar texture. The U.S. Pat. No. 6,104,448 discloses a polymer network that is soluble with the chiral nematic liquid crystal and phase separates to form separated polymer domains. The patent states that the polymer network is distributed in phase separated domains in the cell in an amount that stabilizes the thickness of the structure of the cell. Writing tablets of the prior art are made of a single liquid crystal layer with flexible plastic substrates. Pressure with a stylus draws a monochromatic color image which is the reflective color of the cholesteric planar texture on a black or contrasting color background. The image is erased by applying a voltage pulse to electrodes on the cell that drives the entire cell to the focal conic state.

In addition, there have been various technological approaches to produce a writing pad as a replacement of paper and pencil or chalk on slate. The best known examples are toys. The ETCH-A-SKETCH™, introduced in the 1960s, is one such device. In this device, a movable stylus removes a powder material from inside a screen to make a dark line. The image is erased by turning the device upside down and shaking it to smooth out the surface. Another famous example is the MAGNA DOODLE™, which is a magnetophoretic device in which a stylus with a magnet on the tip is used as the pen to draw a line. The device is erased with a thin long magnet behind the screen. Over 40 million of these devices have been reportedly sold.

Recently, the pressure sensitive cholesteric liquid crystal writing tablet, Boogie Board™ of Improv Electronics has appeared on the market in which a pointed stylus or the finger can be used to write or trace an image on the surface of the tablet. This tablet offers a considerable improvement over previous tablet technologies in that the image can be simply and instantly erased with the push of a button that applies a low voltage pulse electrodes in the tablet. In a cholesteric liquid crystal tablet, the liquid crystal is sandwiched between two substrates that are spaced to a particular gap. The upper substrate is flexible and the bottom substrate is painted with a light absorbing (black or colored) background. The cell gap is usually set by plastic or glass spacers that are either cylindrical or spherical in shape. When one presses on the top substrate with a point stylus or finger, the liquid crystal is locally displaced. Flow induced in the liquid crystal changes its optical texture from a transparent to a brilliant reflective color at the location of the stylus. The reflective color contrasts well to the dark background of the lower substrate. An image traced by the stylus or finger will remain on the tablet indefinitely until erased. Erasure is accomplished by applying a voltage pulse to electrodes transparent conducting electrodes on the inner surface of the substrates that drive the cholesteric liquid crystal for its color reflective state back to its transparent state.

The above described principle is disclosed in more detail in U.S. Pat. No. 6,104,448, incorporated herein by reference. Polymer dispersions can be used to control the pressure sensitivity and resolution of the image as described in US Patent Application Publication 2009/0033811, incorporated herein by reference. Other modes of operation include multiple color images and select erase are described the patent application publication given above as well as US Patent Application Publication 2009/0096942, incorporated herein by reference.

There are other approaches to hand tracing an image on a screen that have been digital in nature but unlike the above examples the traced image does not appear directly on the surface under the stylus or finger but on a remote screen such as a desktop or laptop screen. One such example is the Bamboo Pen Tablet of Wacom Co. Ltd. A specially designed pen is used on a pad surface to sketch, doodle or mark up documents that appear on a computer screen; the image is not seen on the pad surface itself. This writing method is unnatural to the user in that the user must look away from the writing surface to see what is being written, and has difficulty resuming work after a break because it can be problematic to determine where the image of the screen corresponds to a location on the tablet.

It would therefore be desirable to have a writing tablet device, like the cholesteric liquid crystal writing tablet described above, where an image being drawn is directly observed on the writing pad but simultaneously (or subsequently) captured electronically and digitized so as to be observed on a computer screen as well as stored for later recall and use. It is of would be further useful that the device be operable without a special stylus but with any untethered pointed object such as a finger or fingernail. Other features such as low-cost and low-power requirements would be of further advantage.

### SUMMARY OF THE INVENTION

Provided are a plurality of embodiments the invention, including, but not limited to, a writing/drawing tablet with an integrated data capture feature for capturing the image written on the writing/drawing tablet into a memory.

Also provided is a writing/drawing tablet device with data capture comprising: a drawing surface integrated in the tablet and adapted to display back to the user a result of an image drawn or written upon the drawing surface by the user, and a data capture device for capturing the image drawn or written upon the drawing surface for storing in a memory device. The display back to the user of the image drawn or written upon the drawing surface does not require the consumption of electrical power from any power source.

Further provided is the above tablet device where the device has any one or more of the following features:
The drawing surface comprises an LCD for displaying back the image drawn or written on the drawing surface;
The drawing surface comprises a cholesteric LCD for displaying back the image drawn or written on the drawing surface;
The drawing surface is a pressure sensitive drawing surface and wherein the image is drawn or written upon the drawing surface by applying pressure to the drawing surface, and in some embodiments: (1) wherein the pressure is applied to the drawing surface using a stylus, (2) wherein the data capture device is adapted to convert pressure points to electrical signals for capturing the image drawn or written upon the drawing surface into the memory device, and/or (3) wherein the data capture device comprises a touch screen device utilized for capturing the image drawn or written upon the drawing surface into the memory device;
Wherein the data capture device comprises an optical scanning device that is utilized for capturing the image drawn or written upon the drawing surface into the memory device;
Wherein the data capture device comprises a touch screen device utilized for capturing the image drawn or written upon the drawing surface into the memory device;
Wherein the memory device is a flash memory or RAM comprised in the tablet device;
Further comprising a data interface, wherein the memory device is included in an external device communicating with the tablet device utilizing the data interface for capturing the image;
Further comprising a data interface, wherein the memory device is included in an external device communicating with the tablet device utilizing the data interface for capturing the image, wherein the memory device is used to reproduce the image on a remote display included with the external device;
Further comprising an additional display for displaying a replica of the image the captured in the memory device, and in some embodiments wherein the table device is adapted such that additional images previously stored in the memory device can be displayed on the additional display when selected by the user for such display, and in some embodiments further comprising a rechargeable battery for providing power to the tablet device for powering the additional display and in some embodiments further comprising a solar cell for charging the rechargeable battery, and/or further comprising an erase actuator, such that activation of the erase actuator by the user erases the image drawn or written upon the drawing surface by application of a voltage to the drawing surface;
Further comprising an erase actuator, such that activation of the erase actuator by the user erases the image drawn or written upon the drawing surface by application of a voltage to the drawing surface;
Wherein the pressure sensitive data capture surface includes a resistive or inductive touchscreen;
Further comprising a processor for processing the image captured by the data capture device prior to storing the image in the memory device; and/or
Wherein the memory device is included in the tablet, with some additional embodiments further comprising a memory interface wherein the memory device communicates with the tablet via the memory interface and the memory device is removable from the tablet by a user.

Also provided is writing/drawing tablet device with data capture comprising: a power supply for powering the device; a memory storage device; a pressure sensitive drawing surface integrated in the tablet device and adapted to display back to the user a result of an image drawn or written upon the drawing surface by application of pressure by the user, the display back to the user provided without the pressure sensitive drawing surface consuming electrical energy; a switch for erasing the image from the drawing surface by providing electrical energy to the drawing surface when the switch is actuated by a user; a data capture device for electronically capturing the image drawn or written upon the drawing surface into data for storing in a memory device; and a data interface for connecting the tablet device to an external device for communicating with the tablet device for receiving the data.

Further provided is a writing/drawing tablet device with data capture comprising: a pressure sensitive drawing surface including a first substrate having at least one liquid crystal layer and adapted to display back to the user a result of an image drawn or written upon the drawing surface by application of pressure by the user to the drawing surface to locally displace the liquid crystal to change its reflectance in a persistent manner; a pressure sensitive data capture surface including a second substrate for converting the image drawn or written upon the drawing surface into data; and a memory device for storing the data, wherein the data is used for reproducing the image drawn or written upon the drawing surface.

Also provided are any of the above tablet devices where the device has any one or more of the following features:
Further comprising an additional display for displaying an image from the data;
Wherein the pressure sensitive data capture surface includes a resistive or inductive touchscreen device; and/or
Further comprising a processor for processing the data captured by the data capture device prior to storing the data in the memory device.

In addition is provided a method of generating and reproducing an image on a display device, with the method comprising the steps of:
changing a reflectance of a portion of a chemical layer integrated in a drawing surface of the display device in response to a pressure being applied to the portion of the chemical layer for presenting an image on the drawing surface;
converting the image on the drawing surface to data by also utilizing the applied pressure;
storing the data in a memory device connected to the display device; and
reproducing the image on a display different than the drawing surface.

Further provided is the above method having any one or more of the following features:
wherein the presenting an image on the drawing surface does not require application of electrical power;
wherein the image is reproduced on the display different than the drawing surface by utilizing the data stored in the memory device; and/or
wherein the chemical layer includes a cholesteric liquid crystal material.

Also provided are additional embodiments of the invention, some, but not all of which, are described hereinbelow in more detail

### BRIEF DESCRIPTION OF THE DRAWINGS

The features and advantages of the examples of the present invention described herein will become apparent to those skilled in the art to which the present invention relates upon reading the following description, with reference to the accompanying drawings, in which:

FIG. 1: Illustration of a basic cell of a writing tablet of the present invention;

FIG. 1A shows a sketch of an embodiment of a writing/drawing tablet with a touch screen;

FIG. 2: Illustration of the voltage response curves used in describing the invention (with voltage increasing toward the right of the figure and reflectance increasing toward the top of the figure);

FIG. 3: Photograph of inventive writing tablet demonstration of Example 2;

FIG. 4: Schematic illustration of a double stack multicolor writing tablet of the present invention;

FIG. 5: Photograph of a multicolor writing tablet of the invention (Mode A) with focal conic color and planar writing on a planar background;

FIG. 6: Photograph of a multicolor writing tablet of the invention demonstrating gray levels;

FIG. 7: Photograph of a multicolor writing tablet of (Mode B) with planar color writing on a focal conic background;

FIG. 8: Schematic illustration of a triple stack multicolor writing tablet of the present invention;

FIG. 9: Pressure sensitivity and optical response curve;

FIG. 10 shows an embodiment of an optical scanning device illustration;

FIG. 11 shows a block diagram for a writing/drawing tablet with dynamic data upload;

FIG. 12 shows block diagram for a writing/drawing tablet with local memory;

FIG. 13 shows a block diagram for a writing/drawing tablet with an ASIC;

FIG. 14 shows a block diagram for a writing tablet having an additional Review Display; and

FIGS. 15(a) and 15(b) show a front and back view of an artist's conception of one embodiment of a writing tablet information recording device.

### DETAILED DESCRIPTION OF THE EXAMPLE EMBODIMENTS

### I. Cell Having Focal Conic Written Portion on Planar Background

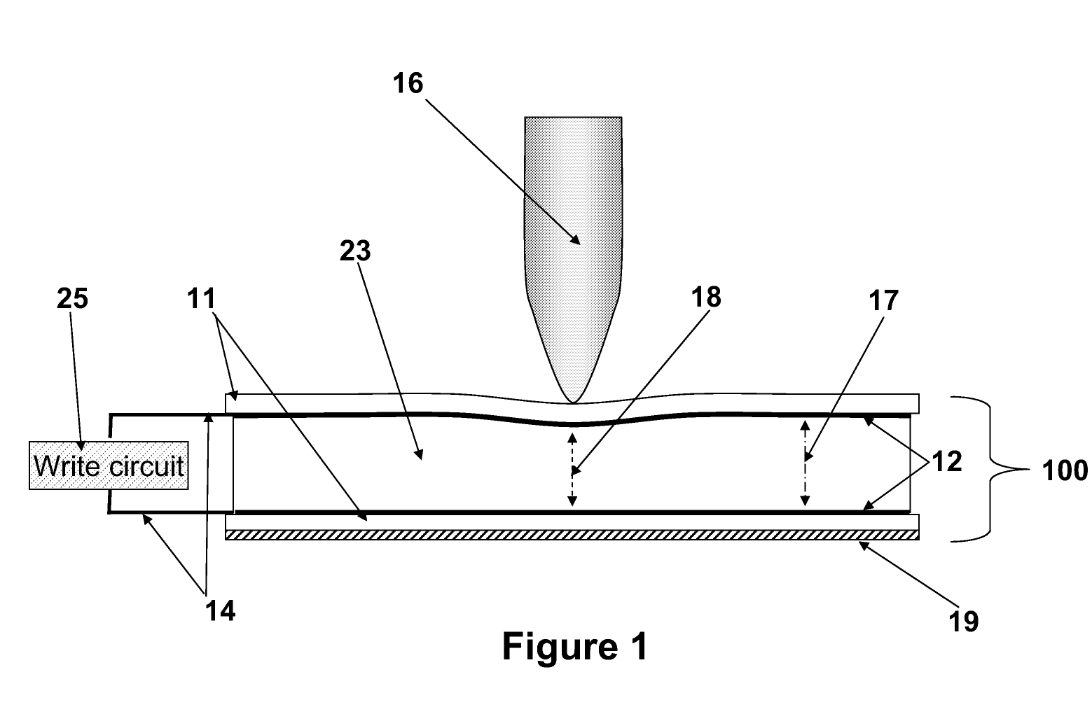

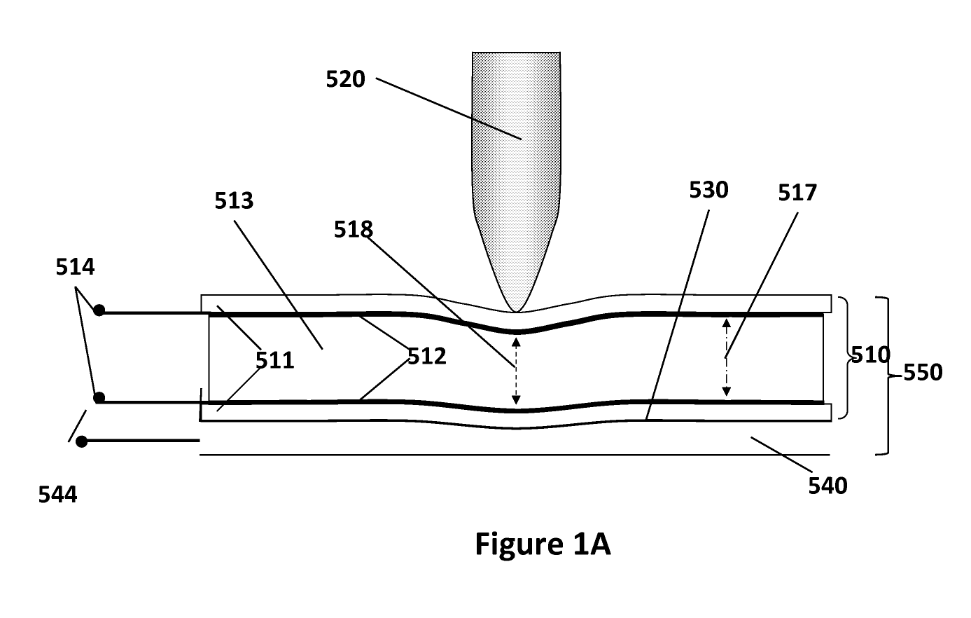

A first embodiment of the present invention is a writing tablet in which the background state is the planar texture and the line created by the pressure of the stylus is in the focal conic texture. The bistable cholesteric writing tablet is illustrated in FIG. 1 and includes substrates 11 of transparent, flexible material in which plastic is preferred. The inner surface of the substrates are coated with transparent conductive electrodes 12 from materials such an indium tin oxide (ITO) or a conducting polymer such as PEDOT. Sandwiched between the adjacent electrodes is a bistable cholesteric material 23.

In all embodiments of the invention, all of the electrodes and substrates are transparent, except for the electrode and any substrate nearest to the light absorbing back layer (e.g., lower electrode 12 and lower substrate 11), which can be transparent or opaque.

In this embodiment in which the liquid crystal is initially in the planar texture, flow of the liquid crystal is not required for the inventive cell to form the focal conic texture using the pressure of a stylus. The droplets can be confined as separate droplets within the dispersion or the droplets can be unconfined with interconnecting droplets. The dispersions may be of the type prepared by water borne emulsions or by polymerization induced phase separation (PIPS) as is known in the art. The image is created by the unique electro-optic characteristics of the cell rather than by flow to be described later. The conducting electrodes 12 are connected with electrical interconnects 14 to electronic write circuitry 25 that provides suitable voltages to the conducting electrodes 12, usually in the form of a pulse, in order for pressure of the stylus to create an image.

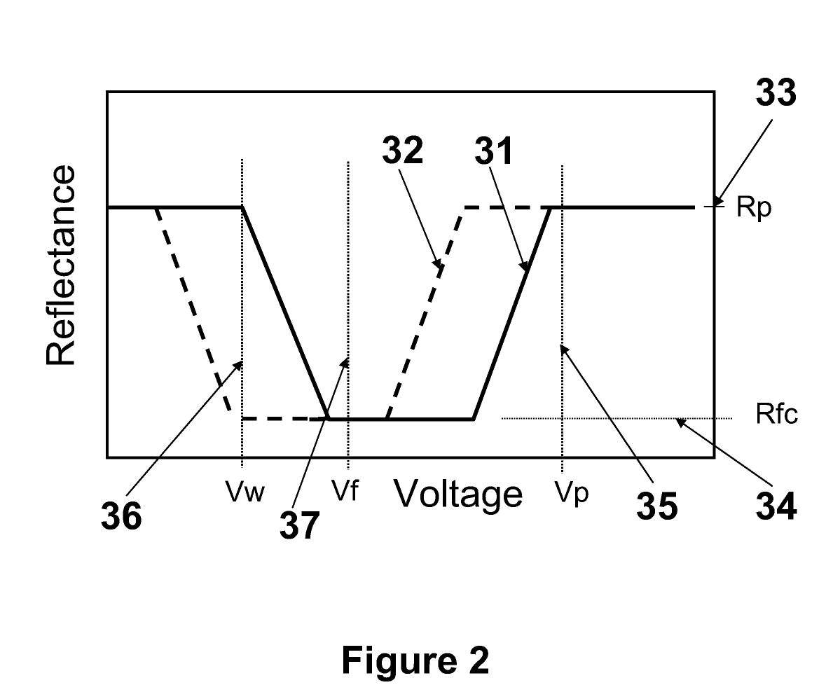

In order to explain the function of the writing circuitry 25 of FIG. 1 we turn to FIG. 2. FIG. 2 is an illustration of the voltage response shown as the Reflectance of the cell versus the Voltage of a pulse applied to the cell. There are two curves illustrated in the voltage response of FIG. 2: a solid curve 31 for the cell with an undepressed cell gap 17 and a dashed curve 32 for a reduced cell gap spacing 18 (the depressed and reduced cell gaps being shown in FIG. 1). In both the solid 31 and the dashed 32 curves of FIG. 2, the maximum light reflectance of the planar texture is indicated by Rp 33 whereas the minimum light reflectance of the focal conic texture is indicated by Rfc 34. As illustrated in FIG. 2 the effect of the pressure from the stylus is to shift the voltage response from the solid curve 31 to the dashed curve 32.

The procedure of writing an image on the inventive cell is to first erase all previous images by applying an erasing voltage of value Vp indicated by vertical line 35 to drive the cell initially to the planar texture. The value of the voltage or magnitude of a voltage pulse to do this is well known in the art of a bistable cholesteric liquid crystal displays; e.g., U.S. Pat. Nos. 5,453,863 and 5,691,795. This erases the writing tablet to the reflective planar texture so that the background color of the writing tablet is a color additive mixture of the reflective color of the cholesteric material 23 with the color of the back layer 19 of FIG. 1.

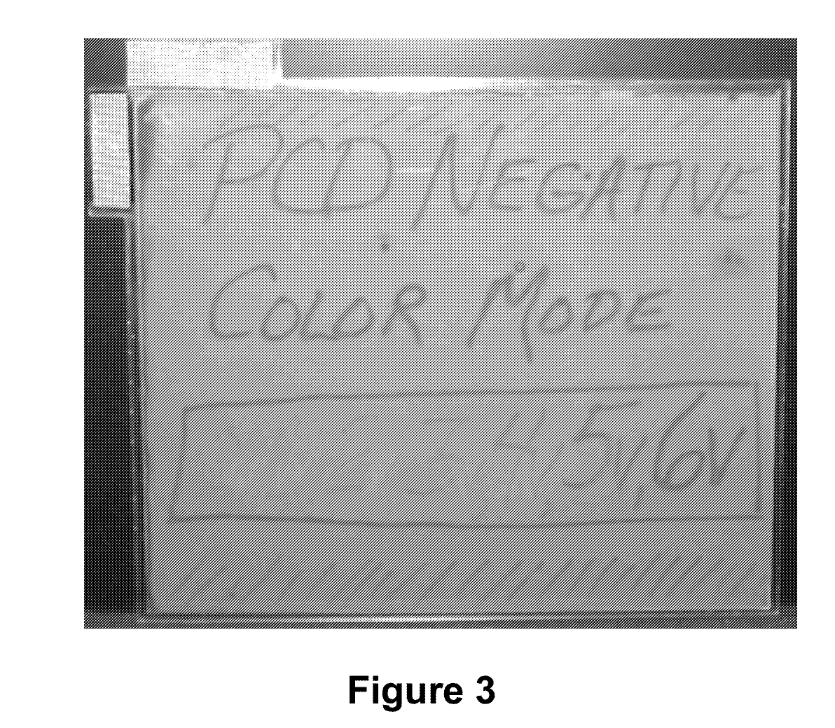

In order to write an image using stylus 16 a voltage, Vw, is applied by the write circuit 25. The value of Vw is indicated by vertical line 36 of FIG. 2. The voltage is applied for the duration of the stylus write; preferably a continuous AC voltage or a sequence of bipolar pulses. The voltage is applied to the patterned or unpatterned electrodes so that the entire display area of liquid crystal seen by the user of the writing tablet, has an electric field applied to it. It is seen by curve 32 in FIG. 2 that a voltage Vw 36 will drive that area of the cell to the focal conic texture; that is, areas of the cell under the stylus where pressure is applied and cell gap is reduced. The planar texture in that area is driven to the focal conic texture as illustrated by the dashed curve 32. In the remainder of the cell where the cell gap is not disturbed, even though the electric field has been applied here, the material will remain in the planar texture as indicated by the solid curve 31, leaving a planar background for the focal conic writing. In other words, the liquid crystal material where the cell gap is undisturbed remains in the planar texture as shown where line Vw intersects the solid line 31 (undepressed cell gap) while the voltage Vw is applied to the electrodes and is not converted to the focal conic texture. An example of the inventive writing tablet cell is photographed in FIG. 3. The write circuit 25 can also provide an erasing voltage Vp to erase the entire tablet. It is seen by FIG. 2 that a voltage Vp 35 will drive the entire cell to the planar texture, erasing the focal conic writing. The voltage may be an AC voltage pulse or a sequence of pulses, preferably bipolar pulses.

References to writing “on a background” used in this disclosure means writing a black or color line on the writing tablet in which a majority of the display area has the background color or is black, and does not mean that the background must be physically behind the writing or formed by a color of the light absorbing back layer. When the word “image” is used in this disclosure it means any black or color line and any black or color background on the writing tablet. When we say “selecting a cell” or “writing on a cell” in this disclosure, that means selecting the writing color to include the color reflected by that cell.

### II. Double Cell Writing Tablet

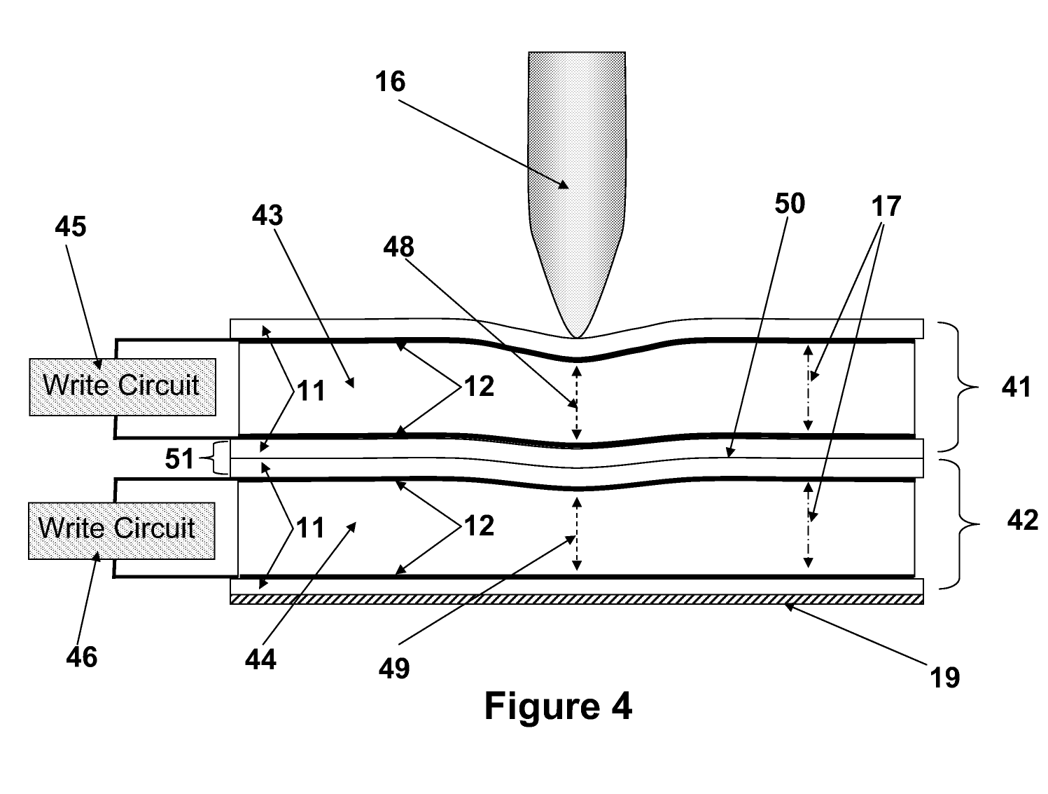

We now turn to a second embodiment of the invention featuring a multiple-color tablet in which two active layers are stacked over each other (FIG. 4). The active layers can be stacked such that each cell reflects a different planar reflective color and images can be written separately on each cell with a single stylus to create multiple color images on the writing tablet. The cholesteric material of the cells each has a pitch length selected to reflect any color; preferably the colors reflected by the two cells are different than each other. Primary such reflective colors can be mixed to create a variety of colors subject to the innovation of the user. The writing tablet enables a single untethered stylus to write or draw figures in different colors as selected by the user. Writing of different colors can be achieved in at least two ways: a first Mode A in which planar texture color writing is presented on a planar texture background; and a second Mode B in which planar texture color writing is presented on a focal conic background, preferably black. Each of these modes works on a different physical principle of the cholesteric liquid crystal and will be described separately below.

The double cell writing tablet device can be made with either stacked separate cells or as a single unit sharing substrates. The word “cell” as used herein means an active layer, the electrodes on either side of it, and any substrates flanking the electrodes (i.e., on either side of the electrodes). In FIG. 4, completed cells 41 and 42 comprising different color active layers can be stacked as separate units each having separate substrate 11 with an electrode 12 on an inside surface of it, the internal substrates 11 being joined with an index matching material 50 in between them. Likewise, the stacked cells can be made as a single unit that shares a common substrate between the active layers 43 and 44, in which case the component structure having interior electrodes 12 on each interior substrate 11 with index matching material 50 between these substrates is replaced by a single substrate designated 51 with two electrodes 12 disposed on either side of it.

### IIa. Double Cell Writing Tablet in Mode A

In describing Mode A, we refer to FIG. 4 which is an illustration of a writing tablet having double stack cells. The multiple-color double-stack tablet of FIG. 4 is made up of two cells, cell 41 stacked on top of cell 42. Cell 41 is of the same construction as cell 100 of FIG. 1 containing transparent substrates 11 with transparent conducting electrodes 12, connected to a writing circuit 25; however the background coating 19 is absent. Cell 41 is stacked on top as well as optically coupled to cell 42 so as to match the index of refraction of adjacent substrates. One means of optical coupling is with a thin layer of optical index matching fluid between cells 41 and 42. Cell 42 is also identical in construction to cell 100 of FIG. 1 with transparent substrates 11 and transparent conducting electrodes 12 that are electrically connected to writing circuit 25 as well as containing background coating 19.

Cells 41 and 42 are filled with a cholesteric liquid crystal material 43 and 44, respectively. However, the cholesteric material within each cell has a different reflective color than the other cell. For example, 41 may be a cholesteric material that reflects blue light while 42 is a cholesteric material that reflects yellow light. In certain applications it may be desired that materials 43 and 44 have a different handedness for the helical twist; that is, one cell reflects right handed circular polarization and the other left. Like the cholesteric material 23 of FIG. 1, the cholesteric materials 43 and 44 of FIG. 4 are preferred to be in the form of a polymeric dispersion. The droplets can be confined as separate droplets within the dispersion since flow of the liquid crystal is not required for this embodiment of the multiple color writing tablet. Materials 43 and 44, however, may also be a droplet dispersion in which the droplets are unconfined with interconnecting droplets since flow will not affect its operation. The dispersions may be of the type prepared by water borne emulsions or by polymerization induced phase separation as is known in the art.

A procedure of writing a multicolor image on the double stack tablet in Mode A is to first erase all previous images by activating both write circuits 45 and 46 to apply voltages of value Vp indicated by vertical line 35 (FIG. 2) to drive both cells 41 and 42 into the planar texture. The value of the voltage or magnitude of a voltage pulse to do this is well known in the art of a bistable cholesteric liquid crystal displays; e.g., U.S. Pat. Nos. 5,453,863 and 5,691,795. This erases the multi-color writing tablet to the reflective planar texture so that the background color of the writing tablet is a color additive mixture of the reflective colors of the cholesteric materials 41 and 42 and any color of the back layer 19.

In order to write an image of the color of the cholesteric 43 on the top cell 41 by stylus 16 in Mode A, a voltage Vw must be applied by the write circuit 46 of the bottom cell 42 during the writing process. The value of Vw is indicated by vertical line 36 of FIG. 2. The voltage is applied for the duration of the stylus write; preferably a continuous AC voltage or a sequence of bipolar pulses. It is seen by curve 32 of FIG. 2 that a voltage Vw 36 will drive the bottom cell to the focal conic texture only in the vicinity of the stylus where pressure is applied and the cell gap is reduced. This removes the planar texture of the liquid crystal 44 in the bottom cell 42 under the stylus (i.e., in reduced gap regions). In the remainder of the bottom cell 42 where the cell gap is not disturbed, the material will remain in the planar texture as indicated by the solid curve 31. Because no voltage is applied to the electrodes for the upper cell 41, the liquid crystal 43 of the upper cell is not changed from the planar texture. This forms an image composed of a written portion (region where pressure is applied by the stylus to the writing surface) containing only the reflected light of the color of the cholesteric 43 of top cell 41 (added with any color of the back layer, referred to as a “back color”) on a background color (formed by the undepressed (unwritten) regions of both cells) that is an additive mixture of the colors of the planar textures of both cells (along with any back color).

In order to write an image of the color of the cholesteric 44 on the bottom cell 42 by stylus 16 in Mode A, a voltage Vw is applied by the write circuit 45 to the top cell 41 while the writing pressure is applied to the writing surface. The value of Vw is indicated by vertical line 36 of FIG. 2. The voltage is applied for the duration of the stylus write; preferably a continuous AC voltage or a sequence of bipolar pulses. It is seen by curve 32 FIG. 2 that a voltage Vw 36 will drive the cholesteric 43 of the top cell 41 to the focal conic texture in the vicinity of the stylus where pressure is applied (i.e., at the written portion of the writing tablet) as the cell gap is reduced. In the remainder of the top cell where the cell gap is not disturbed, the material will remain in the planar texture as indicated by the solid curve 31. Therefore, the image will be composed of the written portion formed by colored light reflected from the planar texture of the cholesteric 44 of only the bottom cell 42 (added to any color of the back layer). The written portion will be apparent on a background color (formed by the undepressed regions of both cells) that is an additive mixture of the colors of the planar textures of both cells (along with any background color).

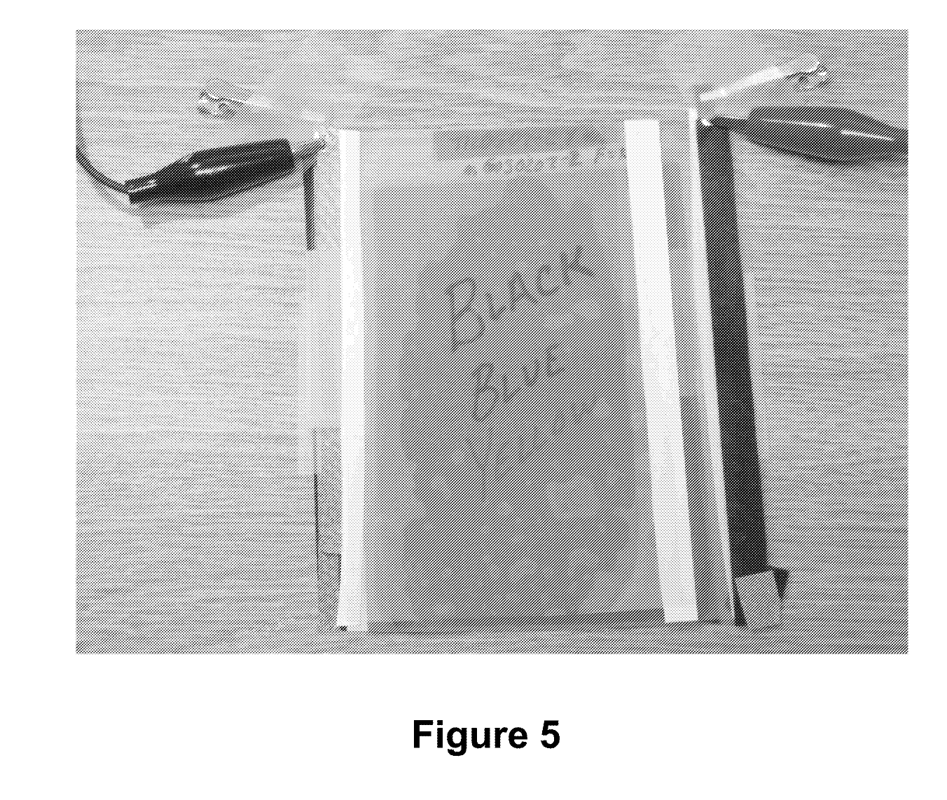

In Mode A, the write circuits 45 and 46 can be used to erase the tablet by providing a voltage Vp to each of cells 41 and 42. It is seen by FIG. 2 that a voltage Vp 35 will drive each of the cells entirely to the planar texture. The voltage may be an AC voltage pulse or a sequence of pulses, preferably bipolar pulses. An example of the inventive multiple color writing tablet of Mode A is described in Example 2 with FIG. 5 showing a double stack writing table, which can be written on in blue, yellow or black with the same untethered stylus. For some possible color combinations that might be achieved using specific initial textures and write voltages, see Tables 1-4 of Example 5.

### IIb. Double Cell Writing Tablet in Mode B

In describing Mode B, we again refer to FIG. 4. The writing tablet is identical to that described above except that the initial state of both cells is focal conic and the cholesteric materials are in the form of a polymeric dispersion that will allow localized flow caused by the writing pressure from a pointed instrument such as a pointed untethered stylus to induce the planar texture. Droplets that are unconfined or are interconnecting allow liquid crystal flow to occur under the pressure of the stylus 16 in reduced cell gap regions 48 and 49. Flow does not occur and the liquid crystal texture does not change in undepressed regions 17.

A suitable voltage applied to the electrodes will drive the cholesteric material of both cells to the initial focal conic state (see FIG. 2). When viewed from above, the tablet will exhibit the color of the background coating 19 since the focal conic texture is essentially transparent in this cell configuration. Black or blue are often preferred for the back layer 19. The pressure from the pointed stylus 16 in the locally reduced cell gap spacing 48, 49 induces flow in the cholesteric material that changes the cholesteric texture from the transparent focal conic to the color reflective planar texture in the vicinity of the tip of the stylus 16. The stylus is used to draw an image similar to drawing with a pencil on paper. The written image can then be entirely erased by applying a voltage pulse to the electrodes of sufficient value to drive all the material 13 to the focal conic state (see FIG. 2 and the '448 patent for suitable voltage to apply to each liquid crystal layer).

The procedure of writing a multicolor image on the double stack writing tablet of Mode B is to first erase all previous images by activating both write circuits 45 and 46 to apply voltages of value Vf indicated by vertical line 37 of FIG. 2 to drive both cells 41 and 42 into the focal conic texture. The value of the voltage or magnitude of a voltage pulse to do this is well known in the art of a bistable cholesteric liquid crystal displays; e.g., U.S. Pat. Nos. 5,453,863 and 5,691,795. In order to write an image reflecting the color of the cholesteric 43 on the top cell 41 only using stylus 16 a voltage Vw is applied by the write circuit 46 to the electrodes of the bottom cell 42 during the writing process. The value of Vw is indicated by vertical line 36 of FIG. 2. The voltage is applied for the duration of the stylus write; preferably a continuous AC voltage or a sequence of bipolar pulses. The purpose of the voltage is to maintain the focal conic texture of the bottom cell 42 under the action of the stylus (i.e., prevent forming the planar texture in the written portion or depressed cell gap region of the bottom cell). While this voltage is applied the pressure of the stylus does not induce a planar texture in cell 42 but maintains its focal conic texture during the writing process. The stylus does, however, induce a planar texture in the cholesteric 43 of the upper cell 41 in its vicinity (i.e., in the writing portion) that is believed to be due to lateral flow of the cholesteric liquid crystal in the reduced gap regions resulting in the focal conic texture being transformed to the planar texture. This occurs without any voltage being applied to the upper cell. Therefore, an image on a focal conic background on a stacked multicolor cell is possible by suitably applying a voltage to allow the image to be written on only one cell. The image is composed of the writing portion at a color of the light reflected from the planar texture of the cholesteric 43 of the top cell 41 (added to any color of the back layer) on the unwritten and undepressed background (black or a back color of the back layer).

Similarly, in order to form an image on the bottom cell 41 only by stylus 16 a voltage Vw must be applied by the write circuit 45 to the electrodes of the top cell 41 during the writing process. As before, both cells are initially in the focal conic texture. The value of Vw is indicated by vertical line 36 of FIG. 2. The voltage is applied for the duration of the stylus write; preferably a continuous AC voltage or a sequence of bipolar pulses. The purpose of the voltage is to maintain the focal conic texture of the top cell 41 under the action of the stylus. While this voltage is applied the pressure of the stylus does not induce a planar texture in top cell 41 but maintains its focal conic texture from the erasure process. The stylus does, however, induce a planar texture in the bottom cell 42 due to induced lateral flow of the cholesteric liquid crystal (without applying voltage to the bottom cell), resulting in the focal conic texture being transformed to the planar texture in the reduced cell gap region of the bottom cell (i.e., in the written portion). This produces an image composed of the writing portion at a color of the light reflected from the planar texture of the cholesteric 44 bottom cell 42 (added to any color of the back layer) on the unwritten and undepressed background (black or a back color of the back layer). Therefore, a planar image on a focal conic background can be selectively written separately on each cell of the stack to produce a multiple color image. Such a multicolor writing tablet is demonstrated in Example 4 with a blue reflective cell stacked on a yellow reflective cell where the colors blue, yellow and white are written on a black background. For some possible color combinations that might be achieved using specific initial textures and write voltages, see Tables 1-4 of Example 5.

### IIc. Multimode Double Cell Writing Tablet

The inventive writing tablet can also be designed so that one of the cells operates according to Mode A and the other cell operates according to Mode B. That is, one cell has an initial planar texture while the other cell has the initial focal conic texture. Writing in a color of only one of the cells (added to any back color) is selected by applying the write voltage Vw to the other cell while writing pressure is applied. The background will have the color of the undepressed regions of the planar cell (added to any back color). For example, when a first cell desired to be selected is in the initial focal conic texture, the other second cell in the planar texture has the writing voltage Vw applied during the writing process. The planar texture is erased from the second layer in the written portion where the cell gap is reduced, as Vw is applied. The writing process forms the planar texture in the written portion of the first layer where the cell gap is reduced. The resulting image will be the written portion at the planar texture of the first layer only (added to any background color) on a background formed by the planar texture of undepressed regions of the second layer (added to any background color).

Another way to form an image on the multimode, two layer writing tablet is by applying the write voltage to both cells, in effect, selecting the background. Upon writing, the planar texture is prevented from being formed in the written portion of the focal conic layer and the planar texture is erased to the focal conic in the written portion of the planar layer. This forms an image composed of a written portion in black or any back color on a background of the color reflected by the planar layer (added to any background color).

Yet another way to form an image on the multimode, two layer writing tablet is by not applying the write voltage to either layer. The writing process will form the planar texture in the written portion of the focal conic layer and will not affect the planar texture existing in the written portion of the other planar layer. This will result in an image that is the addition of the colors reflected from both layers in their written portions (along with any back color) on a background that is the color of light reflected from the planar layer (added to any back layer color).

The writing tablet can be made to produce white on black or black on white using a two cell writing tablet reflecting blue and yellow and having a black back layer. To produce white on black, Mode B is used (both cells are initially in the focal conic state) and no write voltage is applied. This results in the written portion being white (additive mixing of the blue and yellow colors reflected from both cells) on the black back layer seen through the undepressed regions of both cells. To produce black on white, Mode A is used; both cells are initially in the planar texture. During the writing process, the write voltage is applied to both cells. This results in written portions of both cells being focal conic, which shows the black back layer on a background that is white (the additive mixture of the blue and yellow reflected colors).

It should be apparent from the foregoing that the cells can be designed the same or differently by changing the liquid crystal dispersion. In the initially planar cell, liquid crystal flow is not needed to change the planar texture to the focal conic in the layer where the writing voltage is applied. Therefore, the liquid crystal of this cell can be in confined droplets or in a dispersion of liquid crystal in a polymer matrix that does not encapsulate or confine the liquid crystal enabling it to flow. However, the liquid crystal in the initially focal conic cell must be in a dispersion that enables it to flow upon application of pressure from a pointed stylus. This allows the writing tablet to be formed from cells using different combinations of liquid crystal dispersions. For example, a writing tablet could be made so that both cells only have confined droplets of liquid crystal material in a polymer matrix using a PIPS process and will only operate in Mode A only. A writing tablet formed of unconfined droplets in both cells, or a writing tablet having a focal conic cell having unconfined droplets and confined or unconfined liquid crystal in the planar cell, could operate in Mode A, Mode B or in as a multimode writing tablet. For possible color combinations that might be achieved using specific initial textures and write voltages, see Tables 1-4 of Example 5.

### III. Triple Cell Writing Tablet

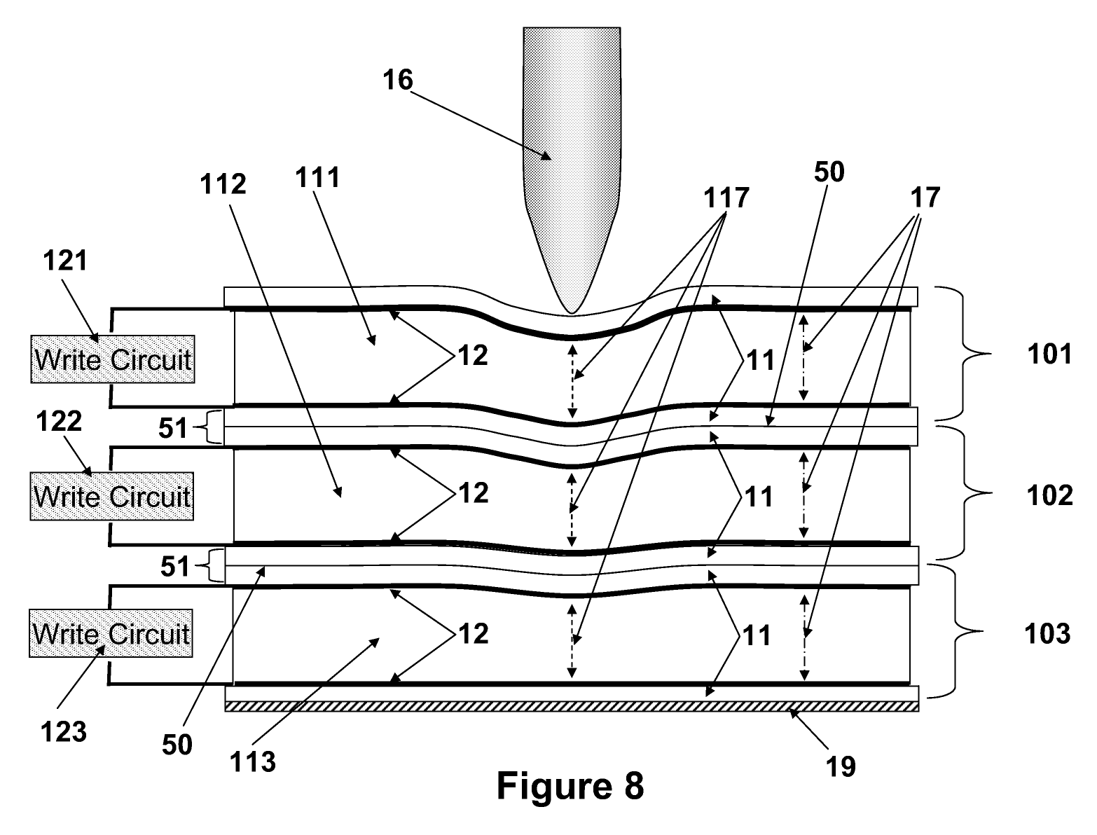

We now turn to FIG. 8 where we disclose a triple stack multicolor writing tablet. The triple-stack tablet of FIG. 8 is made up of cells 101, 102 and 103 stacked as illustrated. Cells 101 and 102 contain transparent substrates 11 with transparent conducting electrodes 12, each connected to a writing circuit. Cell 103 has transparent substrates 11 and transparent conducting electrodes 12 that are electrically connected to the writing circuit. Cell 103 contains background coating 19. Cell 101 is stacked on top of cell 102 which is in turn stacked on top of cell 103 as illustrated in FIG. 8. It is preferred that cells all be optically coupled such as by incorporating a thin layer of optical index matching fluid between cells 101 and 102 and between cells 102 and 103. Cells 101, 102 and 103 are filled with a cholesteric liquid crystal material 111, 112 and 113 respectively. The cholesteric materials of the three cells may each have a pitch length selected to reflect any color; preferably such reflective color of each cell is different than that of the others. Preferred such reflective colors for the triple stack are: blue for liquid crystal material 111; green for liquid crystal material 112 and red for liquid crystal material 113 as these primary colors when additively mixed enable the writing tablet to produce a broad range of color images particularly when shade of gray of each primary color can be invoked. In certain applications it may be desired that materials 111, 112 and 113 have a different handedness for the helical twist; for example, the top 101 and bottom 103 cells reflect right handed circular polarization where as the middle 102 and the other left. Such a configuration maximizes the reflective brightness of the writing tablet. Each of the cholesteric materials 111, 112, and 113 are in the form of a polymeric dispersion.

The triple cell writing tablet device can be made with either stacked separate cells or as a single unit sharing substrates. In FIG. 8, completed cells 101, 102 and 103 comprising different color active layers can be stacked as separate units and be joined with an index matching material 50 in between adjacent substrates. Likewise, the stacked structure can be made as a single unit that shares a common substrate between the active layers 101 and 102 or 102 and 103 as described above for the double stack display.

The triple stack includes Mode A in which a planar or focal conic line is written on a planar background and Mode B in which a planar line is written on a focal conic background. In the case of Mode A the droplets in a dispersion can be confined as separate droplets within the dispersion since flow of the liquid crystal is not required for this embodiment of the multiple color writing tablet. The dispersions may be of the type prepared by water borne emulsions or by polymerization induced phase separation as is known in the art. In Mode B the materials 111, 112 and 113 are droplet dispersions that allow localized flow sufficient to induce the planar texture. Droplets that are unconfined or are interconnecting allow flow to occur under the pressure of stylus 16 where the cell gap in the vicinity of the stylus 117 is reduced from its cell gap 17 elsewhere in the writing tablet.

### IIIa. Triple Cell Writing Tablet in Mode A

The procedure of writing a multicolor image on the triple-stack writing tablet in Mode A is to first erase all previous images by activating all write circuits 121, 122 and 123 to apply voltages of value Vp indicated by vertical line 35 of FIG. 2 to drive cells 101, 102 and 103 into the initial planar texture. The value of the voltage or magnitude of a voltage pulse to do this is well known in the art of a bistable cholesteric liquid crystal displays; e.g., U.S. Pat. Nos. 5,453,863 and 5,691,795. This erases the multi-color writing tablet to the reflective planar texture so that the background color of the writing tablet is a color additive mixture of the reflective colors of the cholesteric materials 111, 112 and 113 and any back color of the back layer 19. Using the preferred reflective colors of blue, green and red for materials 111, 112 and 113 respectively and the black back layer 19, the additive mixture will provide a white background.

In order to write an image on the top cell 101 using stylus 16, a voltage Vw must be applied by write circuit 122 and 123 to cells 102 and 103 during the writing process. The value of Vw is indicated by vertical line 36 of FIG. 2. For all embodiments of the invention it should be noted that the value of Vw depends on the color of the cholesteric liquid crystal for a given cell thickness. The threshold voltage (Vw) is inversely proportional to the cholesteric pitch length, which is defined as the length it takes for a 360° rotation of the liquid crystal molecules. So, Vw for a blue cholesteric layer will be at a higher voltage than for a red cholesteric layer for the same cell gap. The voltage is applied for the duration of the stylus write; preferably a continuous AC voltage or a sequence of bipolar pulses. It is seen by curve 32 FIG. 2 that a voltage Vw 36 will drive cell 102 and 103 to the focal conic texture in the vicinity of the stylus where pressure is applied and cell gap is reduced. In the remainder of the cells where the cell gap is not disturbed, the material will remain in the planar texture as indicated by the solid curve 31 leaving the original background color. This produces an image composed of the written portion at the reflected color of the top cell 102 only on a background that is an additive mixture of the colors reflected by the planar texture of all three cells (along with any back color).

In order to write an image on the middle cell 102 only using stylus 16, a voltage Vw must be applied by the write circuits 121 and 123 of top and bottom cells 101 and 103, respectively, during writing. The value of Vw is indicated by vertical line 36 of FIG. 2. The voltage is applied for the duration of the stylus write; preferably a continuous AC voltage or a sequence of bipolar pulses. It is seen by curve 32 of FIG. 2 that a voltage Vw 36 will drive the top 101 and bottom 103 cell to the focal conic texture in the vicinity of the stylus where pressure is applied and cell gap is reduced. In the remainder of the cells where the cell gap is not disturbed, the material will remain in the planar texture as indicated by the solid curve 31. This produces a written line having a color of the middle cell only (additive of any back color) on a background that is an additive mixture of the colors reflected by the planar texture of all three cells (along with any back color).

In order to write an image on the bottom cell 103 only using stylus 16, a voltage Vw must be applied by the write circuits 121 and 122 of the upper and middle cells 101 and 102, respectively. The value of Vw is indicated by vertical line 36 of FIG. 2. The voltage is applied for the duration of the stylus write; preferably a continuous AC voltage or a sequence of bipolar pulses. It is seen by curve 32 of FIG. 2 that a voltage Vw 36 will drive the top 101 and middle 102 cell to the focal conic texture in the vicinity of the stylus where pressure is applied and cell gap is reduced. In the remainder of the cells where the cell gap is not disturbed, the material will remain in the planar texture as indicated by the solid curve 31. This results in a written portion having a color of the bottom cell only (additive of any back color) on a background that is an additive mixture of the colors reflected by the planar texture of all three cells (along with any back color).

Operating in Mode A, write circuits 121, 122 and 123 can be used to erase the tablet (i.e., remove all color writing from the tablet) by providing a voltage Vp to each of cells 101, 102, and 103. It is seen by FIG. 2 that a voltage Vp 35 will drive all three cells entirely to the planar texture. The voltage may be an AC voltage pulse or a sequence of pulses, preferably bipolar pulses.

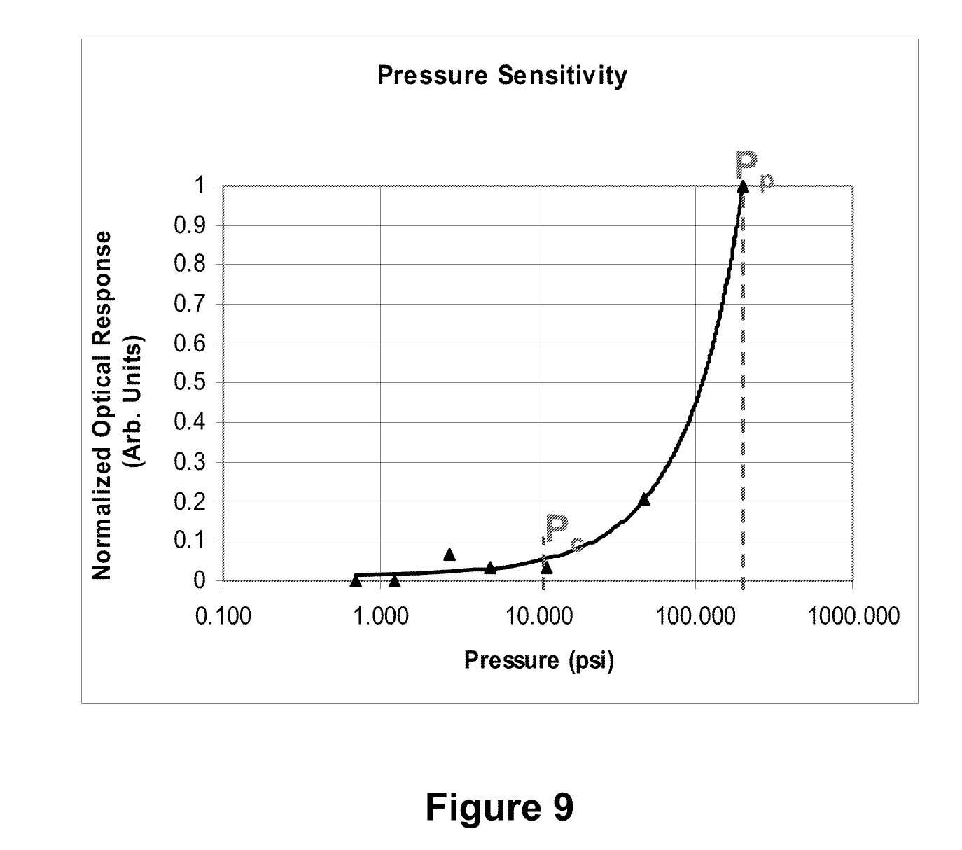

Written portions of grayscale color can be achieved in Mode A by applying either a reduced write voltage (V<Vw) or by reducing the force applied by the stylus to the display during the write. By reducing the write voltage to a value less than Vw during the write, one can see in FIG. 2 that the reflectance begins to increase, i.e., one is not inducing as many focal conic domains. In FIG. 9, (see Example 6) we can see that if one applies a writing pressure P where P_{c}<P<Pₚ, one can induce a grayscale planar texture. For the full color system, writing a grayscale color using the reduced voltage method is preferable as a reduced pressure would require Vf voltages applied to the other layers that will change with the cell gap, i.e., pressure applied by the stylus. Mixing of colors when the cells are at different gray levels can be used to provide a broad range of colors. A preferred triple stack writing tablet in Mode A reflects blue, green and red and has a black backlayer. This preferred writing tablet can produce a written portion of a select color of one or two of the layers on a white background. When the write voltage is applied to all of the cells of the preferred writing tablet, a black on white image can be obtained. For some possible color combinations that might be achieved using specific initial textures and write voltages, see Tables 5-12 of Example 5.

### IIIb. Triple Cell Writing Tablet in Mode B

The procedure of writing a multicolor image on a triple-stack writing tablet in Mode B is to first erase all previous images by activating write circuits 121, 122, and 123 to apply voltages of value Vf indicated by vertical line 37 of FIG. 2 to drive cells 101, 102 and 103 into the initial focal conic texture. The value of the voltage or magnitude of a voltage pulse to do this is well known in the art of a bistable cholesteric liquid crystal displays; e.g., U.S. Pat. Nos. 5,453,863 and 5,691,795. This erases the multi-color writing tablet to the reflective focal texture revealing the black or color of the back layer 19.

To write an image on the top cell 101 only, using stylus 16 a voltage Vw must be applied by the write circuits 122 and 123 to the electrodes of the middle and bottom cells 102 and 103, respectively, during the writing process. The value of Vw is indicated by vertical line 36 of FIG. 2. The voltage is applied for the duration of the stylus write; preferably a continuous AC voltage or a sequence of bipolar pulses. The purpose of the voltage is to maintain the focal conic texture of cells 102 and 103 in the written region where the cell gap is reduced by the action of the stylus. While this voltage is applied the pressure of the stylus does not induce a planar texture in the written portions of cells 102 and 103 but the focal conic texture of these cells is maintained during the writing process. The stylus 19 does, however, induce a planar texture in the reduced gap region of cell 101 in its vicinity that is believed to be due to lateral flow of the cholesteric liquid crystal resulting in the focal conic texture being transformed to the planar texture. This occurs even though no voltage is applied to the upper cell. The image will be a written portion composed of the color from the planar texture of the top cell 101 only (additive with any back color) on a background of the back layer 19 (black or a back color). Therefore, a planar image on a focal conic background on a stacked multicolor cell is possible by suitably applying a voltage to allow an image to be written on only on cell.

Similarly, in order to write an image on the middle cell 102 only, using stylus 16 a voltage Vw is applied by the write circuit 121 and 123 to the electrodes of the top and bottom cells 101 and 103 during the writing process. The value of Vw is indicated by vertical line 36 of FIG. 2. The voltage is applied for the duration of the stylus write; preferably a continuous AC voltage or a sequence of bipolar pulses. The purpose of the voltage is to maintain the focal conic texture in the written portions of cells 101 and 103. While this voltage is applied the pressure of the stylus does not induce a planar texture in cells 101 and 103 but the focal conic texture of these cells is maintained during the writing process. The stylus does, however, induce a planar texture to middle cell 102 due to induced lateral flow of the cholesteric liquid crystal resulting in the focal conic texture in the written portion or reduced cell gap region of the middle cell being transformed to the planar texture. This occurs even though no voltage is applied to the middle cell. The image will be a written portion composed of the color from the planar texture of the middle cell 102 only (additive with any back color) on a background of the back layer 19 (black or a back color).

Similarly, in order to write an image on the bottom cell 103 only using stylus 16 a voltage Vw is applied by the write circuit 121 and 122 to the electrodes of the top and middle cells 101 and 102 during the writing process. The value of Vw is indicated by vertical line 36 of FIG. 2. The voltage is applied for the duration of the stylus write; preferably a continuous AC voltage or a sequence of bipolar pulses. The purpose of the voltage is to maintain the focal conic texture of cells 101 and 102 under the action of the stylus. While this voltage is applied the pressure of the stylus does not induce a planar texture in the written portions of the upper and middle cells 101 and 102 but maintains their focal conic texture during the writing process. The stylus does, however, induce a planar texture to bottom cell 103 in the written portion thereof due to induced lateral flow of the cholesteric liquid crystal resulting in the focal conic texture being transformed to the planar texture. Therefore a planar image on a focal conic background can be selectively written separately on each cell of the stack to produce a multiple color image. The image will be a written portion composed of the color from the planar texture of the bottom cell 103 only (additive with any back color) on a background of the back layer 19 (black or a back color).

A preferred three cell writing tablet in Mode B has respective reflective colors of the cholesteric liquid crystal layers 111, 112 and 113 that are blue, green and red as well as a background coating 19 that is black. The preferred triple stack writing tablet in Mode B can also produce a written portion of one or two select colors of one or two of the layers on the black background. These primary colors can be mixed to create intermediate colors. For example, the color of each layer can be placed at different levels of reflectivity or shades of gray, enabling images of multiple colors to be achieved by controlling the pressure of the stylus or by suitably controlled voltages less than voltage level Vw. In addition, when no write voltage is applied to all three cells of the preferred writing tablet, a written white on black background can be obtained when operating the preferred three cell writing tablet in Mode B. For some possible color combinations that might be achieved using specific initial textures and write voltages, see Tables 5-12 of Example 5.

Writing tablets including additional stacked cells beyond the triple stack are possible with various combinations or reflective wavelengths including infrared and ultraviolet in addition to differing cholesteric materials such has different circular polarization handedness.

### IIIc. Triple Cell Writing Tablet in Multimode

The triple cell writing tablet of FIG. 8 can operate in a multimode where the initial states are: two cells are focal conic and the third cell is planar; or where two cells are planar and the third cell is focal conic. This enables the following possibilities. Where the initial states are as follows: two cells are focal conic and the third is planar, 1) the writing tablet can produce a written portion that includes the selected color of one of the active layers on a background color that includes the color of one of the layers. This configuration also permits 2) forming a written portion that includes the additive mixing of the colors from two of the layers on a background color that includes the color of one of the layers. Where the initial states are as follows: two cells are planar and the third is focal conic, 3) a written portion can include the color of one selected layer on a background color that is an additive mixture of the colors of two of the layers. This also permits the possibility of 4) a written portion including a color that is the additive mixture of colors from two of the active layers on a background that includes the colors of two of the active layers. For some possible color combinations that might be achieved using specific initial textures and write voltages, see Tables 5-12 of Example 5.

The applications of writing tablets are endless such as for toys, artist easels, wall mounted “white boards,” sketch pads, refrigerator or appliance mounted tablets, office signs, store signs, other signage, office furniture etc.

The inventive writing tablet can be used with an optically transparent touch screen overlay (e.g., MicroTouch Flex Capacitive Touch Sensor supplied by 3M Touch Systems, Inc.) so that when writing onto the touch screen through to the writing tablet below, the touch screen would register where the writing is made, enabling images written on the writing tablet to be stored. In addition, touch screen overlays such as the MicroTouch Flex Capacitive Touch Sensor can be easily integrated in a roll-to-roll process with the writing tablet system since they are both plastic, can be manufactured roll-to-roll and can be simply laminated together.

Not only can touchscreen overlays be integrated with the inventive writing tablet, the writing tablet itself can be made into a capacitive touchscreen sensor by simply modifying the electronics to both scan at Vw and sense either the applied voltage and/or current. If the top and bottom substrates are patterned with conductors in a row column format, the cell gap change may be mapped by tracking the current flowing between row and column or a capacitive change between row and column (which may require a frequency sweep during the Vw scan). In Mode A, the display is being scanned at Vw. This Vw scan can be used as either a capacitive or current probe. If one maps the change in capacitance or the change in current with respect to the row/column coordinate (location), one can digitally map the writing input and store this as an image. In this manner the writing tablet becomes a touch screen where the visual information is updated in real-time but the digital input is stored to a screen map that can be digitized.

The invention will now be described by reference to the following examples to illustrate, rather than limit, the invention.

### Example 1

A bistable cholesteric writing tablet 100 (FIG. 1) was fabricated to demonstrate the inventive effect of utilizing the characteristics of the voltage response curve to write an image with the pressure of an untethered stylus comprising a written portion in the focal conic texture on a planar texture background. A writing tablet cell with a 4 micron cell gap was constructed from 2 substrates and an active layer. The top and bottom substrates were made from 2 mil thick Polyethylene Terephthalate (PET) that had an unpatterned electrode made from a Meyer rod coated PEDOT-based conducting polymer (AGFA) covering the entire surface area of the interior surface of both substrates. The active layer consisted of a polymer-dispersed yellow (580 nm) cholesteric liquid crystal (Merck).

The active layer of the writing tablet is made from a blend of polymerizable monomer (prepolymer) and cholesteric liquid crystal. The dispersion was created by non-encapsulating polymerization induced phase separation of a cholesteric liquid crystal using monomer chemistry similar to what is described in U.S. Pat. No. 7,351,506 B2. The active layer of the writing tablet was made from using a UV curable methacrylate-based monomer, acrylate-based cross-linker, diphenyl photoinitiator, and 4 micron spherical polyvinylidine spacers. The mixture consisted of:
75% (wt.) KLC19 (Kent Displays, Inc.) cholesteric liquid crystal premixed to selectively Bragg reflect yellow light at the desired peak reflective wavelength of 580 nm
25% (wt.) photo-polymerizable monomer consisting of:
   81.6% (wt.) methyl methacrylate
   14.7% (wt.) trimethylolpropane triacrylate
   2.0% (wt.) Irgacure 651 (Ciba Specialty Chemicals)
   1.7% (wt.) lauryl methacrylate

The spherical plastic spacers were added to the system at 3% (wt.) of the total weight of the liquid crystal/monomer mixture. The mixture was than laminated between the two conductive polymer coated PET substrates. The system was cured by exposure to UV light at 0.92 mW/cm² irradiance for 15 minutes. After curing the polymerizable mixture, the cell is backpainted blue and then laser-singulated (as described in US Patent Application Publication 2007/0277659A1) to the desired shape.

Electrical connections were made with silver tape, an electrically conductive tape (Adhesives research), attached to both the top and bottom ledge where the conductive polymer electrode is exposed. The display was attached to a 1/16 inch thick clear acrylic backer for mounting support. The display and backer were then mounted in a frame. The electronics are attached to the conductive tape to complete fabrication of the writing tablet. The writing tablet electronics create a voltage sufficient to switch the LC material and to apply this voltage to the display electrodes in a specific sequence. Typically this requires a voltage boost circuit to transform the given battery voltage to a higher voltage optimized for switching or writing on the display. This is accomplished using a traditional switching inductor supply or capacitive charge pump supply circuit. The display has two connections relating to the top substrate electrode and the bottom substrate electrode respectively. Analog switches select either high voltage or ground for each electrode. This selection is controlled by a microcontroller or other such display controller so that the analog switches can be switched in such a sequence to create the proper waveform. The waveform and magnitude of the voltage pulse to switch the display are well known in the art of a bistable cholesteric liquid crystal displays; e.g., U.S. Pat. Nos. 5,453,863 and 5,691,795. Selecting the various waveforms and magnitudes of the write voltage Vw for the liquid crystal layer would be apparent to one of ordinary skill in the art in view of this disclosure (e.g., FIG. 2) and that of these patents.

The procedure for writing on the tablet is to first apply a voltage pulse to erase the cell to the planar texture. A 40 volt 100 ms AC square wave voltage pulse (square wave periodicity of 10 ms) was applied to the electrodes of the tablet to drive the cholesteric cell to the planar texture. In this texture, the writing tablet appears white because the yellow reflective color of the cholesteric planar texture additively mixes with the blue paint on the back of the cell to produce a white color. In order to write an image, a continuous AC square wave voltage Vw of 6 volts was applied to the electrodes while applying pressure on the tablet either with a pointed stylus or finger nail. A photograph of the writing tablet operating in Mode A is shown in FIG. 3 (with electronics detached) where it is seen that the image appears as a blue line on white background since the pressure of the stylus with a voltage applied to the electrodes drives the cholesteric material to the transparent focal conic texture showing the blue back layer of the tablet cell.

In order to demonstrate the effect of the writing voltage on the gray scale levels of the cell, different voltages below 6 volts were applied with identical pressure while writing showing that the reflectivity of the written portion increased as the voltage is lowered (decreasing contrast of the image by making the written portion have a brighter reflectivity closer to that of the background). It is seen that the image vanished nearly altogether below 4 volts. This indicates that gray levels can be achieved by varying the voltage and that in this case the gray level region is approximately between 4 and 6 volts. The entire writing tablet could be erased by applying a 50 volt AC square wave waveform to the electrodes across the electrodes for 100 ms in duration, placing the entire cell in the planar texture. It should be noted that one is also able to achieve a grayscale with the device by changing the writing pressure while applying a constant 6V. Higher pressure results in a darker (less reflective) written portion (due to the reduced cell gap while under application of Vw) whereas lower pressure results in a brighter (more reflective) written portion for a constant voltage. The written portion becomes darker or lighter depending on the density of the focal conic to planar domains in the reduced gap region (e.g., written portions become darker by reducing the density of planar/focal conic domains in the reduced gap region).

### Example 2

A double stack multiple color writing tablet, as schematically shown in FIG. 4 with both cells in Mode A was constructed enabling writing the colors blue, yellow or black on a white background as selected by the user with the same untethered stylus. A first or upper cell 41 was constructed identical to the writing tablet cell of Example 1 with a 4 micron cell gap spacing except that the cholesteric liquid crystal (Merck) was selected to be one that Bragg-reflects blue light at a peak wavelength of approximately 470 nm. Furthermore, no background coating was placed on the upper cell so that all of the incident visible light that was not reflected by the cholesteric material of the first cell passed through it. A second cell 42 was constructed identical to the writing tablet cell 100 of Example 1 with a 4 micron cell gap spacing and with the cholesteric liquid crystal that reflects yellow light at a peak wavelength of approximately 580 nm. The second cell contained a black background coating 19. The first cell was fixedly stacked on top of the second cell with one drop of isopropyl alcohol in between adjacent substrates of the cells to serve as an optical index matching material. Electrical connections to the displays were made with an electrically conductive woven silver tape (Adhesives research), attached to both the top and bottom ledges of both cells where the conductive polymer electrode is exposed. A function generator (Analogic Polynomial Waveform Synthesizer Model 2020) and amplifier (Kepco BOP500M) were connected to the silver tape electrodes of the cells using alligator clips, FIG. 5.

The cells were first erased to the planar state by applying a 50V, 100 ms pulse with a 10 ms period bipolar square to the electrodes of the top and bottom cells. With these pulses both cells were switched to the planar texture and the writing tablet exhibited a white reflective color as the blue color of the top cell and yellow color of the bottom cell additively mixed to yield white. A black image was then written on the stacked multicolor tablet by applying a continuous 6V square wave voltage Vw with a 10 ms periodicity to the electrodes of both the top 41 and bottom 42 cells while writing the word “BLACK”. Notice the resultant black color word “BLACK” written on the white display as shown in the photograph of FIG. 5. The voltage was removed from the electrodes and the image remained as photographed.

A blue image was written on the multicolor tablet by applying a continuous 6V square wave voltage Vw with a 10 ms periodicity to the electrodes of the bottom yellow cell 42 only while the pressure of a pointed stylus was applied to write the word “BLUE” as shown in the photograph of FIG. 5. The voltage was removed from the electrodes and the images remained as photographed.

A yellow image was then written on the multicolor tablet by applying a continuous 6V square wave voltage Vw with a 10 ms periodicity to the electrodes of the top cell only while the pressure of a pointed stylus was used to write the word “YELLOW” as shown in the photograph of FIG. 5. The voltage was removed from the electrodes and the images remained as photographed. The images could then be erased to show a white field on the display by applying a 50V, 100 ms pulse with a 10 ms period bipolar square to the electrodes of the top and bottom cells.

### Example 3

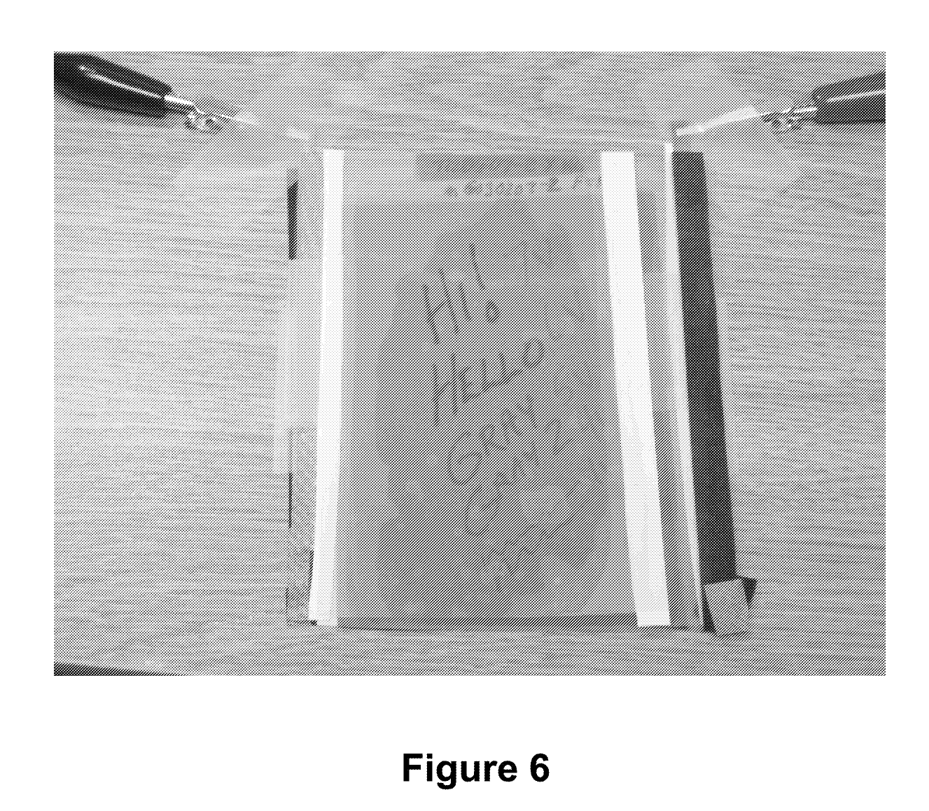

Gray level capability of the double stack multicolor writing tablet in Mode A was demonstrated by using the double stack multicolor writing tablet of Example 2. To demonstrate gray levels, both the top and bottom cells were erased to the planar texture by applying a 50V, 100 ms pulse with a 10 ms period bipolar square to the electrodes of the top cell and of the bottom cell providing a white background. A black image was then written on the stacked multicolor tablet by first applying a continuous square wave voltage Vw with a 10 ms periodicity to the electrodes of both the top and bottom cell. The uniform pressure of a pointed weighted stylus was then used to write various words on the display while Vw was applied to the electrodes of both cells. The first word, “HI!” as shown in the photograph of FIG. 6, was written at 7V using the continuous square waveform with a 10 ms periodicity. The value of the continuously applied voltage was then stepped down to 6V and the stylus used to write the image “HELLO” as shown in the photo of FIG. 6. The value of the continuously applied voltage was then stepped down to 5V and the stylus used to write the image “GRAY” where it is shown in the photo of FIG. 9 to be less contrasting than the 6V or 7V images. The value of the continuously applied voltage was then stepped down to 4V and the stylus used to write the image “GRAY 2” where it is shown in the photo of FIG. 6 to be less contrasting than the 5V image. A further reduction in voltage to 1V showed further reduction in contrast where the image was barely visible in the photograph. This clearly demonstrates the levels of gray are possible to achieve on the multicolor writing tablet (i.e., the reflectivity of the writing increased as the values of Vw applied during writing decreased). With gray level capability, numerous colors become possible on a stacked multicolor writing tablet in that mixed gray levels of different colors additively mix to achieve intermediate colors on a chromaticity chart.

### Example 4

We constructed a multiple color writing tablet of Mode B using a double stack writing tablet schematically depicted in FIG. 4 on which can be written images in the colors blue, yellow or white on a black background as selected by the user with the same untethered stylus. In this Example we used the same double stacked writing tablet of Examples 2 and 3 (using first blue cell 41 and second yellow cell 42 and nonencapsulating PIPs processing of the polymer dispersed liquid crystal material. The writing tablet was first erased to the focal conic texture by applying a 20V, 100 ms pulse with a 10 ms period bipolar square to the electrodes of the top cell and of the bottom cell. With these pulses both cells were switched to the focal conic texture and the writing tablet exhibited a black reflective color since the focal conic texture is transparent revealing the black color of the background coating 19 of the bottom cell.

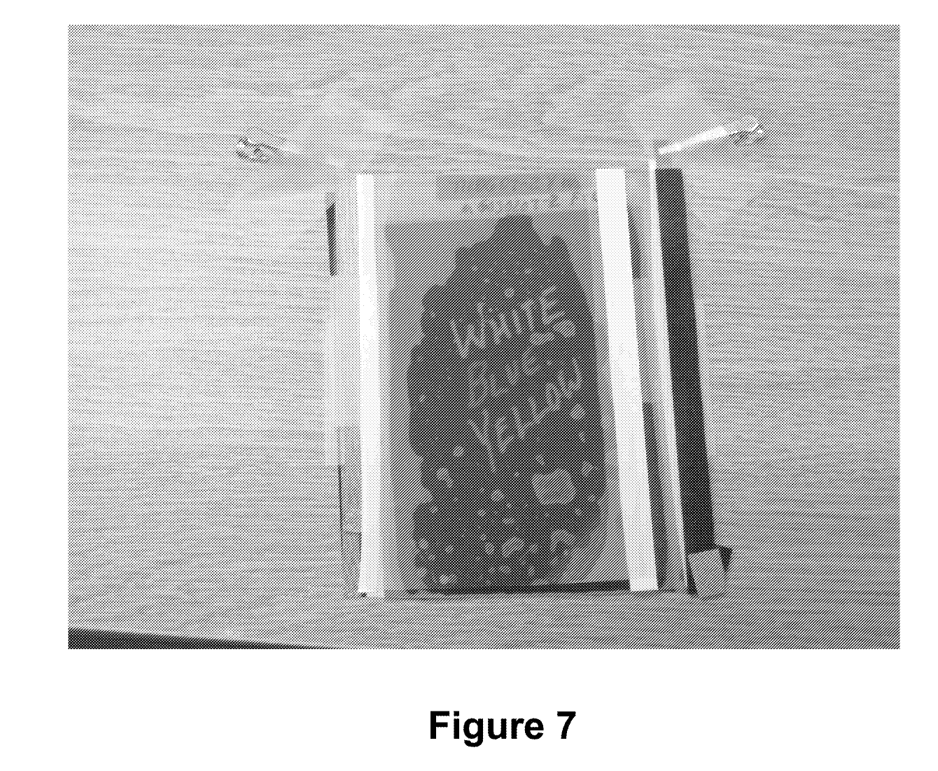

A white image was then written on the stacked multicolor tablet by the pressure of a pointed stylus. FIG. 7 shows a photograph of such an image in which the stylus was used to write the word “WHITE”. Note that no voltage was applied to the cells during the writing process. The pressure of the stylus induced flow in the liquid crystal which further induced the planar texture. Liquid crystal flow under the stylus tip induced the blue planar texture in the upper cell as well as the yellow planar texture in the lower cell. Both of these colors additively mixed to yield the white reflective color on the black background of the multicolor writing pad.

A blue image was then written on the multicolor tablet by applying a continuous 6V square wave voltage Vw with a 10 ms periodicity to the electrodes of the bottom (yellow) cell 42 only and the pressure of a pointed stylus then used to write the word “BLUE” as shown in the photograph of FIG. 7. Note that in this case, voltage applied to the electrodes of the lower (yellow) cell 42 maintain the focal conic texture of the lower cell so that no planar image is written on that cell. However, a blue image is written on the upper cell 41 without applying any voltage to the electrodes of that cell, where flow drives the focal conic texture to the planar texture in the vicinity of the stylus.

A yellow image was then written on the multicolor tablet by applying a continuous 6V square wave voltage Vw with a 10 ms periodicity to the electrodes of the top cell 41 only and the pressure of a pointed stylus then used to write the word “YELLOW” as shown in the photograph of FIG. 9. Note that in this case, voltage applied to the electrodes of the upper (blue) cell 41 maintains the focal conic texture of the upper cell so that no planar image is written on that cell. However, a yellow image is written on the lower cell 42 without applying any voltage to the electrodes of that cell, where flow drives the texture to the planar texture in the vicinity of the stylus. The multicolor image on the writing tablet could be erased by applying a 20V, 100 ms pulse with a 10 ms period bipolar square to the electrodes of the top cell and of the bottom cell.

### Example 5

The following Tables 1-4 illustrate some possible color images that might be produced by a two cell writing tablet where the cells are in the indicated states upon application of the indicated writing voltages. A two cell writing tablet that was actually made and achieved some of these images is described in the examples (Modes A and B). Other images described in Tables 1-4 below are conceptually possible. The writing tablet would have cell 1 as a top cell stacked over a bottom cell 2. A black back layer would be located below cell 2 to absorb light passing through cells 1 and 2. The chiral additives of cells 1 and 2 would enable the cholesteric liquid crystal of cells 1 and 2 to reflect blue and yellow, respectively, when in the planar texture. The addition of light reflected from both layers may appear white.

It should be understood that the cholesteric liquid crystal materials can be modified to reflect any desired color rather than the yellow and blue colors noted here. This would produce an additive mixture of these colors where appropriate instead of the white noted here. The indicated color images when at least one of the cells is in the focal conic texture would be achieved when the writing is at an intended normal writing pressure. If a color back layer is used, the writing color, as well as the background color, would be the color of the back layer alone (instead of the color black where indicated in the tables) or the back color additively mixed with the colors indicated below. This could also change conditions where there is no image. Gray scale is possible when varying writing pressure (see Example 6) or writing voltage (see FIG. 2) but the various possible color combinations are not shown here. It will be apparent that using gray scale many colors can be produced by the inventive writing tablet.

TABLE 1
Mode A (White Background)

| | | | | [Writing Color] on |
|---|---|---|---|---|
| | 2 Layer Color | Active | Active | (Background |
| | Combination | Layer 1 | Layer 2 | Color) |
| Initial Active | | Planar | Planar | (white) |
| Layer State | | | | |
| Vw applied | 1 | No | Yes | [blue] on (white) |
| Vw applied | 2 | Yes | No | [yellow] on (white) |
| Vw applied | 3 | Yes | Yes | [black] on (white) |
| Vw applied | 4 | No | No | [white] on (white) |
| | | | | No image |

TABLE 2
Mode B (Black Background)

| | | | | [Writing Color] on |
|---|---|---|---|---|
| | 2 Layer Color | Active | Active | (Background |
| | Combination | Layer 1 | Layer 2 | Color) |
| Initial Active | | focal | focal | (black) |
| Layer State | | conic | conic | |
| Vw applied | 5 | No | Yes | [blue] on (black) |
| Vw applied | 6 | Yes | No | [yellow] on (black) |
| Vw applied | 7 | No | No | [white] on (black) |
| Vw applied | 8 | Yes | Yes | [black] on (black) |
| | | | | No Image |

TABLE 3
Multimode (Yellow Background)

| | | | | [Writing Color] on |
|---|---|---|---|---|
| | 2 Layer Color | Active | Active | (Background |
| | Combination | Layer 1 | Layer 2 | Color) |
| Initial Active | | focal | Planar | (yellow) |
| Layer State | | conic | | |
| Vw applied | 9 | No | No | [white] on (yellow) |
| Vw applied | 10 | Yes | Yes | [black] on (yellow) |
| Vw applied | 11 | No | Yes | [blue] on (yellow) |
| Vw applied | 12 | Yes | No | [yellow] on (yellow) |
| | | | | No Image |

TABLE 4
Multimode (Blue Background)

| | | | | [Writing Color] on |
|---|---|---|---|---|
| | 2 Layer Color | Active | Active | (Background |
| | Combination | Layer 1 | Layer 2 | Color) |
| Initial Active | | Planar | focal | (blue) |
| Layer State | | | conic | |
| Vw applied | 13 | Yes | No | [yellow] on (blue) |
| Vw applied | 14 | Yes | Yes | [black] on (blue) |
| Vw applied | 15 | No | No | [white] on (blue) |
| Vw applied | 16 | No | Yes | [Blue] on (blue) No |
| | | | | Image |

The following Tables 5-12 illustrate some conceptually possible color images that might be produced by a triple cell writing tablet in the indicated initial states upon application of the indicated writing voltages. This writing tablet would have cell 1 as a top cell stacked over a middle cell 2, and cell 2 would be stacked over cell 3. A black back layer would be located below cell 3. The chiral additives of cells 1, 2 and 3 would enable the cholesteric liquid crystal of cells 1, 2 and 3 to reflect blue, green and red, respectively, when in the planar texture. It should be understood that the cholesteric liquid crystal materials can be modified to reflect any desired color rather than the blue, green and red colors noted here. This would produce an additive mixture of these colors where appropriate instead of the white noted here. The indicated color images when at least one of the cells is in the focal conic texture would be achieved when the writing is at an intended normal writing pressure. If a color back layer is used, the writing color, as well as the background color, would be the color of the back layer alone (instead of the color black where indicated in the tables) or the back color additively mixed with the colors indicated below. This could also change conditions where there is no image. Gray scale is possible when varying writing pressure (see Example 6) or writing voltage (see FIG. 2) but the various possible color combinations are not shown here. It will be apparent that using gray scale thousands of colors can be produced by the inventive writing tablet.

TABLE 5
Full Color Mode A (White Background)

| | 3 Layer | | | | |
|---|---|---|---|---|---|
| | Color | Active | Active | Active | [Writing Color] on |
| | Combination | Layer 1 | Layer 2 | Layer 3 | (Background Color) |
| Initial | | planar | planar | planar | (white) |
| Active | | | | | |
| Layer | | | | | |
| State | | | | | |
| Vw | 1 | No | Yes | Yes | [blue] on (white) |
| Vw | 2 | Yes | No | Yes | [green] on (white) |
| Vw | 3 | Yes | Yes | No | [red] on (white) |
| Vw | 4 | Yes | Yes | Yes | [black] on (white) |
| Vw | 5 | No | No | No | [white] on (white) |
| | | | | | No Image |
| Vw | 6 | Yes | No | No | [green + red = |
| | | | | | yellow] |
| | | | | | on (white) |
| Vw | 7 | No | Yes | No | [blue + red = |
| | | | | | magenta] |
| | | | | | on (white) |
| Vw | 8 | No | No | Yes | [blue + green = |
| | | | | | cyan] |
| | | | | | on (white) |

TABLE 6
Full Color Mode B (Black Background)

| | 3 Layer | | | | |
|---|---|---|---|---|---|
| | Color | Active | Active | Active | [Writing Color] on |
| | Combination | Layer 1 | Layer 2 | Layer 3 | (Background Color) |
| Initial | | focal | focal | focal | (black) |
| Active | | conic | conic | conic | |
| Layer | | | | | |
| State | | | | | |
| Vw | 9 | No | Yes | Yes | [blue] on (black) |
| Vw | 10 | Yes | No | Yes | [green] on (black) |
| Vw | 11 | Yes | Yes | No | [red] on (black) |
| Vw | 12 | No | No | No | [white] on (black) |
| Vw | 13 | Yes | Yes | Yes | [black] on (black) |
| | | | | | No Image |
| Vw | 14 | Yes | No | No | [green + red = |
| | | | | | yellow] |
| | | | | | on (black) |
| Vw | 15 | No | Yes | No | [blue + red = |
| | | | | | magenta] |
| | | | | | on (black) |
| Vw | 16 | No | No | Yes | [blue + green = |
| | | | | | cyan] |
| | | | | | on (black) |

TABLE 7
Multimode (Yellow Background)

| | 3 Layer | | | | |
|---|---|---|---|---|---|
| | Color | Active | Active | Active | [Writing Color] on |
| | Combination | Layer 1 | Layer 2 | Layer 3 | (Background Color) |
| Initial | | focal | planar | planar | (green + red = |
| Active | | conic | | | yellow) |
| Layer | | | | | |
| State | | | | | |
| Vw | 17 | No | Yes | Yes | [blue] on |
| | | | | | (green + red = |
| | | | | | yellow) |
| Vw | 18 | Yes | No | Yes | [green] on |
| | | | | | (green + red = |
| | | | | | yellow) |
| Vw | 19 | Yes | Yes | No | [red] on |
| | | | | | (green + red = |
| | | | | | yellow) |
| Vw | 20 | No | No | No | [white] on |
| | | | | | (green + red = |
| | | | | | yellow) |
| Vw | 21 | Yes | Yes | Yes | [black] on |
| | | | | | (green + red = |
| | | | | | yellow) |
| Vw | 22 | Yes | No | No | [green + red = |
| | | | | | yellow] on |
| | | | | | (green + red = |
| | | | | | yellow) |
| | | | | | No Image |
| Vw | 23 | No | Yes | No | [blue + red = |
| | | | | | magenta] on |
| | | | | | (green + red = |
| | | | | | yellow) |
| Vw | 24 | No | No | Yes | [blue + green = |
| | | | | | cyan] on |
| | | | | | (green + red = |
| | | | | | yellow) |

TABLE 8
Multimode (Blue Background)

| | 3 Layer Color | Active | Active | Active | [Writing Color] on |
|---|---|---|---|---|---|
| | Combination | Layer 1 | Layer 2 | Layer 3 | (Background Color) |
| Initial Active | | planar | focal | focal | (blue) |
| Layer State | | | conic | conic | |
| Vw | 25 | No | Yes | Yes | [blue] on (blue) No Image |
| Vw | 26 | Yes | No | Yes | [green] on (blue) |
| Vw | 27 | Yes | Yes | No | [red] on (blue) |
| Vw | 28 | No | No | No | [white] on (blue) |
| Vw | 29 | Yes | Yes | Yes | [black] on (blue) |
| Vw | 30 | Yes | No | No | [green + red = yellow] |
| | | | | | on (blue) |
| Vw | 31 | No | Yes | No | [blue + red = magenta] |
| | | | | | on (blue) |
| Vw | 32 | No | No | Yes | [blue + green = cyan] |
| | | | | | on (blue) |

TABLE 9
Multimode (Magenta Background)

| | 3 Layer Color | Active | Active | Active | [Writing Color] on |
|---|---|---|---|---|---|
| | Combination | Layer 1 | Layer 2 | Layer 3 | (Background Color) |
| Initial Active | | planar | focal conic | planar | (blue + red = magenta) |
| Layer State | | | | | |
| Vw | 33 | No | Yes | Yes | [blue] on |
| | | | | | (blue + red = magenta) |
| Vw | 34 | Yes | No | Yes | [green] on |
| | | | | | (blue + red = magenta) |
| Vw | 35 | Yes | Yes | No | [red] on |
| | | | | | (blue + red = magenta) |
| Vw | 36 | No | No | No | [white] on |
| | | | | | (blue + red = magenta) |
| Vw | 37 | Yes | Yes | Yes | [black] on |
| | | | | | (blue + red = magenta) |
| Vw | 38 | Yes | No | No | [green + red = yellow] |
| | | | | | on |
| | | | | | (blue + red = magenta) |
| Vw | 39 | No | Yes | No | [blue + red = magenta] |
| | | | | | on |
| | | | | | (blue + red = magenta) |
| | | | | | No Image |
| Vw | 40 | No | No | Yes | [blue + green = cyan] |
| | | | | | on |
| | | | | | (blue + red = magenta) |

TABLE 10
Multimode (Green Background)

| | 3 Layer Color | Active | Active | Active | [Writing Color] on |
|---|---|---|---|---|---|
| | Combination | Layer 1 | Layer 2 | Layer 3 | (Background Color) |
| Initial Active | | focal conic | planar | focal | (green) |
| Layer State | | | | conic | |
| Vw | 41 | No | Yes | Yes | [blue] on (green) |
| Vw | 42 | Yes | No | Yes | [green] on (green) |
| | | | | | No Image |
| Vw | 43 | Yes | Yes | No | [red] on (green) |
| Vw | 44 | No | No | No | [white] on (green) |
| Vw | 45 | Yes | Yes | Yes | [black] on (green) |
| Vw | 46 | Yes | No | No | [green + red = yellow] |
| | | | | | on (green) |
| Vw | 47 | No | Yes | No | [blue + red = magenta] |
| | | | | | on (green) |
| Vw | 48 | No | No | Yes | [blue + green = cyan] |
| | | | | | on (green) |

TABLE 11
Multimode (Cyan Background)

| | 3 Layer | | | | |
|---|---|---|---|---|---|
| | Color | Active | Active | Active | [Writing Color] on |
| | Combination | Layer 1 | Layer 2 | Layer 3 | (Background Color) |
| Initial | | planar | planar | focal | (blue + green = |
| Active | | | | conic | cyan) |
| Layer | | | | | |
| State | | | | | |
| Vw | 49 | No | Yes | Yes | [blue] on |
| | | | | | (blue + green = |
| | | | | | cyan) |
| Vw | 50 | Yes | No | Yes | [green] on |
| | | | | | (blue + green = |
| | | | | | cyan) |
| Vw | 51 | Yes | Yes | No | [red] on |
| | | | | | (blue + green = |
| | | | | | cyan) |
| Vw | 52 | No | No | No | [white] on |
| | | | | | (blue + green = |
| | | | | | cyan) |
| Vw | 53 | Yes | Yes | Yes | [black] on |
| | | | | | (blue + green = |
| | | | | | cyan) |
| Vw | 54 | Yes | No | No | [green + red = |
| | | | | | yellow] on |
| | | | | | (blue + green = |
| | | | | | cyan) |
| Vw | 55 | No | Yes | No | [blue + red = |
| | | | | | magenta] on |
| | | | | | (blue + green = |
| | | | | | cyan) |
| Vw | 56 | No | No | Yes | [blue + green = |
| | | | | | cyan] on |
| | | | | | (blue + green = |
| | | | | | cyan) |
| | | | | | No Image |

TABLE 12
Multimode (Red Background)

| | 3 Layer Color | Active | Active | Active | [Writing Color] on |
|---|---|---|---|---|---|
| | Combination | Layer 1 | Layer 2 | Layer 3 | (Background Color) |
| Initial Active | | focal conic | focal | planar | (red) |
| Layer State | | | conic | | |
| Vw | 57 | No | Yes | Yes | [blue] on (red) |
| Vw | 58 | Yes | No | Yes | [green] on (red) |
| Vw | 59 | Yes | Yes | No | [red] on (red) No |
| | | | | | Image |
| Vw | 60 | No | No | No | [white] on (red) |
| Vw | 61 | Yes | Yes | Yes | [black] on (red) |
| Vw | 62 | Yes | No | No | [green + red = yellow] |
| | | | | | on (red) |
| Vw | 63 | No | Yes | No | [blue + red = magenta] |
| | | | | | on (red) |
| Vw | 64 | No | No | Yes | [blue + green = cyan] |
| | | | | | on (red) |

### Example 6

We constructed a single layer writing tablet as outlined in Example 1 for the purposes of evaluating pressure sensitivity and grayscale. When the writing tablet operates in Mode B in which the entire writing surface is initially in the focal conic state, a sufficient force per unit area is applied with a stylus to reduce the electrode gap. As the electrode gap is decreased, liquid crystal is displaced and flows away from the pressure point, resulting in a reduced thickness of the liquid crystal in the region. As the liquid crystal flows, it causes the cholesteric liquid crystal to align to the planar state that remains stable after flow has stopped. The highly reflective planar state contrasts with the nearly transparent focal conic state to give the impression of bright writing on a dark background.

Selective pressure sensitivity is preferable for a practical writing tablet as one writes with a hand resting on the writing surface. The inventive writing tablet is selectively pressure sensitive; i.e., the planar reflective texture is only induced from the focal conic texture when a sufficiently localized force per unit area is able to change the electrode gap. If the force is distributed over a large area, the electrode gap is insignificantly changed or not changed at all, and the liquid crystal does not flow enough to induce the planar texture. So, if one rests or drags their hand across the display while writing, no information is recorded. However, if one presses into the display with a narrowly distributed force of a pointed stylus (i.e., with pointed pressure), the liquid crystal flows and the planar texture is induced.

FIG. 9 shows the optical response of an exemplary writing tablet to pointed pressure. The critical pressure is denoted P_{c} and is approximately 10 pounds per square inch (psi). Notice that when P<P_{c}, the device has no optical response, i.e., it does not switch to the planar state and is pressure insensitive. (The solid triangles in the figure are the normalized optical response as measured by the reflectivity of the written texture given by the Minolta Spectrophotometer CM-508d. The line is a fit to the data and shows the overall optical-pressure response.) The lack of optical response is due to the fact that the pressure was not sufficient enough to displace the liquid crystal and induce flow, i.e., the solid polymer/spacer structure was sufficient to support the applied pressure without allowing a deflection of the top substrate. When P>P_{c}, the device is pressure sensitive and writes to the planar state, i.e., the liquid crystal is displaced, flows and ends up in a planar texture. Pₚ is the pressure required to write a 100% planar texture and is seen in FIG. 9 where the optical response saturates around 200 psi or so. A grayscale in the optical response may be written by applying a pressure P where P_{c}<P<Pₚ.

The polymer dispersion has three functions: to support the substrates keeping them from delaminating from a negatively applied force, to keep the top conductor from touching the bottom conductor from a positively applied force and to restrict the flow of cholesteric liquid crystal such that sharp lines and high contrast are possible. In all embodiments of the invention the image is bistable in that no electric field is needed to maintain the image on the display, including gray scale images.

Writing Tablet with Data Capture Features

Provided in this section are embodiments of an electronic writing/drawing tablet that incorporates a data capture feature described in more detail, some examples of which are discussed above.

An electronic writing/drawing tablet, some examples of which are discussed in detail above, is a design that can be based on Kent Displays' Reflex technology disclosed in U.S. Pat. No. 6,104,448 and in U.S. patent application Ser. Nos. 12/152,862; 12/152,729; and 12/220,805, all incorporated herein by reference, and which can be utilized for various embodiments of a writing/drawing tablet having a data capture feature. The reflex technology disclosed in these references makes use of the special pressure sensitivity of certain materials, in particular in a cholesteric polymer composite system by converting the writing pressure into visible track on the tablet. Several consumer product designs have evolved and been considered as the ideal replacement for writing paper. Various embodiments of the invention disclose several ways to integrate memory function and/or data capture functions into such writing/drawing tablets to overcome the identified shortcomings.

One approach is to use a state-of-the-art data capture device, such as a touch screen, to capture the information being drawn on the tablet drawing surface. For example, a simple, low cost touch screen provided on the back of the writing/drawing surface can be utilized to capture the stylus movement by utilizing the capture features of the touch screen, as illustrated in FIG. 1A, described in more detail below.

There are many touch input methods that can be used with the writing/drawing tablet as proposed herein to provide the data capture feature, such as are provided by capacitive, inductive, resistive, optical, acoustic, and other touch-input technologies. The touch screen can, for many applications, utilize relatively low resolution technology such as a resistive touch screen, and such a screen could even avoid the use of the traditional transparent conductor, ITO, because it can be provided behind the writing surface because the writing surface can be made flexible. Likewise a touch screen behind the writing surface is also possible with such other touch screen technologies such as the inductive method since the writing surface is transparent to the inductive stylus. The resistive and inductive methods are examples that will not interfere with the intended operation of the tablet.

The writing/drawing tablet with the integrated touch screen would not likely require extensive processing capability integrated into the device itself, (i.e., can have minimal “smarts”) for most such applications. The combination writing/drawing tablet drawing surface and touch screen would preferably be adapted to be connected to an external device, such as a computer or cell phone, for example, which could then provide any necessary processing capability (i.e., have all of the “smarts”). Alternatively, some processing capability can also be provided in the tablet itself in order to perform some rudimentary processing, such as ND conversion, minor image processing, and/or memory management functions, for example. Features controlling the transmission of stored images to an external device, or for display on an integrated preview display as an additional display, can also be supported.

The connection between the tablet and the external device can be wired or wireless, as desirable for the intended application. Thus as examples, for a wired connection, a direct wired connection, or a USB or other serial port connection could be utilized, or even an Ethernet connection for some embodiments. For wireless connectivity, a WiFi, Bluetooth, infrared, or other connection mechanism could be utilized. In some embodiments, both wired and wireless connections might be provided, although the desire to keep the cost of the tablet low and reduce power consumption might limit the number of features that one provides in some embodiments of the tablet.

For many applications, it is desirable to reduce the cost of the recordable writing/drawing tablet significantly by utilizing the processing capability of the external device whenever possible. Of course, the processing capability could be integrated into the tablet, if desired, when an external device is either not available, or does not have sufficient processing capability for the intended application, or to provide a more self-contained tablet. Thus, the tablet could have a processor (such as a microcontroller, CPU, or other type of processor) incorporated therein to provide sufficient processing in the device. Dedicated processors for implementing the desired interface (e.g., USB, Ethernet, WiFi, Bluetooth, etc.) could be utilized, and may be available off-the-shelf with either commercially available, or customized, software/firmware. A processor, ND device, or other electronics might be provided to digitize the image drawn on the tablet, and such devices are known to be used with some touch screen applications.

Furthermore, the tablet might incorporate a memory device, such as RAM, EEPROM, a hard drive, or other data storage mechanism, to store images drawn on the display within the device for later download to a computer or other device. This could enable the device to store hundreds, thousands, or more images in the memory. Such memory devices might be removable, such as a USB drive or flash memory commonly available for digital photography and music storage, for example. A preferred embodiment of the tablet includes a slot for insertion of commercially available removable flash memory.

There are many data capture options, including many touch input methods, that can be used with writing tablets to obtain data capture functionality, such as pressure sensitive touch screens, inductive touch screens, optical touch screens, acoustic touch screens, capacitive touch screens, and others. The touch screen can be a relatively low resolution screen that may not even need to use the traditional transparent conductor, ITO, (because for this use it is provided behind the drawing surface, and thus transparency may not be necessary). The touch screen device would preferably have minimal “smarts” as discussed above, although processing can be provided to increase the functionality and/or flexibility of the implementation. The combination writing/drawing surface and touch screen would be connected to an external device such as a computer or cell phone, which would have all of the “smarts”, when processing was desired. The connection can be wired or wireless, as discussed above. The point is to reduce the cost of the recordable tablet by using the smarts in the external device as much as possible.

A preferred example embodiment utilizes a pressure sensitive resistive type touch screen for the data capture feature, whereby the location of the stylus is recorded by its location on a resistive pad provided on the back side of the drawing surface of the writing tablet, as illustrated in FIG. 1A. In FIG. 1A, a stylus, 520, provides pressure to the electronic writing tablet drawing surface 510 including two flexible substrates, 511, each with transparent conductive electrodes, 512 located on the inner surface. A pressure sensitive cholesteric liquid crystal dispersion, 513, rests between the electrodes. Pressure from the stylus, 520, creates a smaller gap distance 518, compared to the relaxed distance 517, which causes the liquid crystal to flow and change the cholesteric texture from a transparent focal conic texture to a reflective, stable planar texture which becomes a visible image to the eye when contrasted on a dark, usually black background as provided by a light adsorbing layer, 530. Thus, the image is drawn on the writing surface and displayed to the user without the consumption of electrical power, as the image is formed by the distortion of the liquid crystal caused by the stylus pressure, and the image is persistent due to the bistable nature of the liquid crystal.

Of course, in an alternative embodiment, the image could be provided as a negative of the above described process by providing a light reflective light background that becomes transparent in response to the stylus pressure under an applied voltage exposing a dark light absorbing background. Either embodiment can be used to display an image due to the contrast between the background and the portion of the liquid crystal that was deformed by the pressure, thereby producing the desired image.

The image is erased by applying voltage pulses to the electrodes 512, via the interconnects 514, such as disclosed in U.S. Pat. No. 6,104,448 and U.S. patent application Ser. Nos. 12/152,862 and 12/220,805, incorporated by reference. Thus, electrical power is required only for erasing the image and putting the liquid crystal back into a neutral state for receiving the next drawing image. There is little or no power consumption during the drawing phase using the above described embodiment. Alternative embodiments may utilizes some electrical power for the drawing process, such as for various contrast improving functions, for example, but in any case, it does not require any power to maintain a stable image on the display due to the bistable nature of the liquid crystal utilized for the device.

In the above described embodiment of the invention (see FIG. 1A), a pressure sensitive touch screen, 540, is placed adjacent to the writing tablet 510 to provide an integrated writing and recording tablet 550. In the case of a pressure sensitive touch screen such as a resistive one, pressure from the stylus 520 is transferred through the writing pad 510 to the touch screen 540, indicating its position or location on the touch screen. The resistive data from the touch screen is transferred to digital recording electronics via electrodes 544. There can be a plurality of electrodes 544 depending upon the type of resistive touch screen utilized. This particular embodiment is preferred because of its low cost, simplicity, and the fact that it can be made very thin and light in weight. A commercial touch screen can be used in this embodiment or it can be custom designed to be better integrated with the touch screen. Alternative embodiments can utilize other types of touch screen technologies, such as an inductive touchscreen when the tablet is paired with a stylus adapted for such a use, for example.

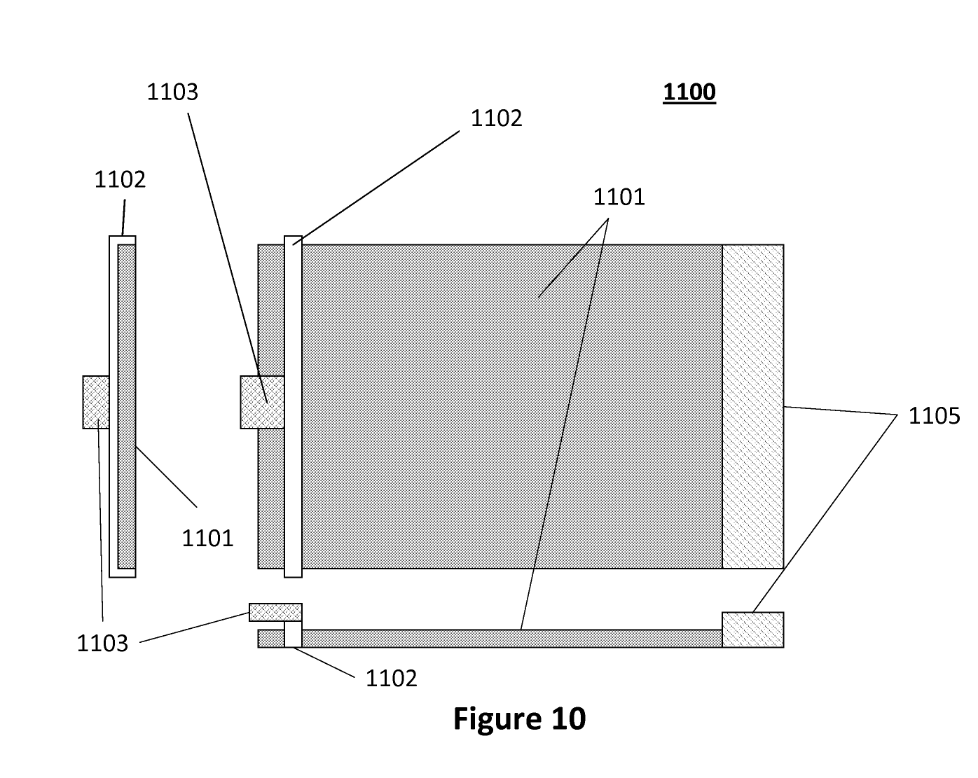

Another embodiment to capture the image using a data capture device other than a touch screen could use a 1D scanning image array, such as illustrated in FIG. 10, which shows a top view and two different side views of the device. In FIG. 10, the electronic tablet with scanner 1100 is comprised of a tablet 1101 on its mount 1105 with a 1D optical scanner 1102, which is drawn (swiped) by hand or electromechanically across the tablet. Suitable electronics 1103, including, for example, a microcontroller, a battery, and an SD card, electronically captures and digitally records the image as the optical scanner 1102 is swiped. This embodiment could be designed in as part of the tablet or manufactured and sold separately as, for example, an add-on feature.

In still another embodiment not requiring a touch screen technology, a 2D image optical sensor (such as might be utilized for a digital camera, for example) can be used to capture and digitally record the image from the front of the tablet. Alternatively, by placing a sensor behind the liquid crystal layer, the image can then be captured by monitoring the intensity of light being transmitted through the liquid crystal layer, thus capturing the image by the image sensor for transmission to the tablet electronics for storage and/or transmission to the external device.

In any of the methods and designs disclosed above, the captured data can be sent to a desktop PC, laptop, PDA, or cell phone via wireless or wire link. Another option is to store the captured image on local flash memory, or internal memory, of the device itself. Several different designs for the inventive device to perform this function are described in more detail, hereinbelow.

With the consideration of the compactness integration, durability, low power, and convenience of use, any of the following embodiments of the tablet could be provided to capture the image drawn on the tablet on an external device:

1. A Writing/Drawing Tablet with Dynamic Data Upload:

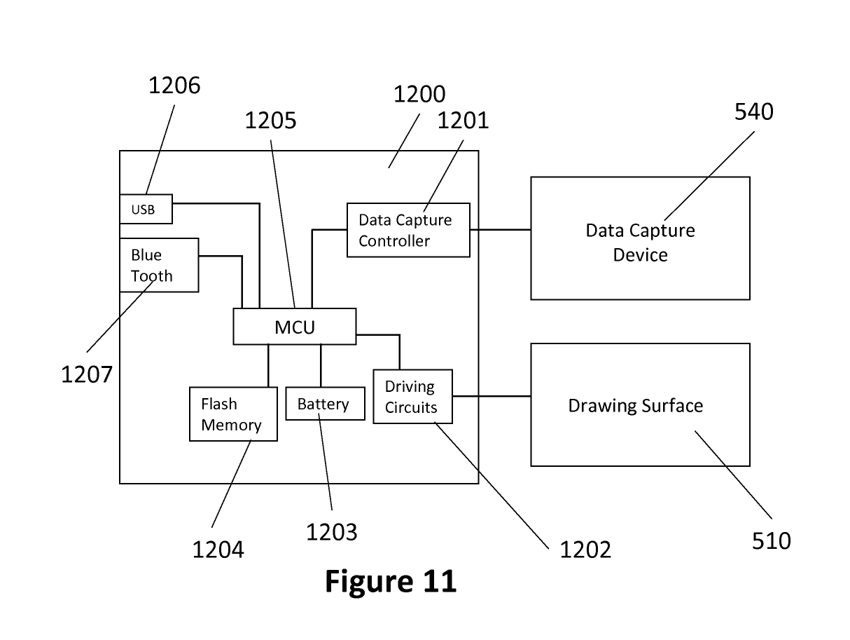

The general design block diagram of this example embodiment is shown in FIG. 11. It includes a writing/drawing tablet 510, a touch screen 540, and associated electronic circuitry 1200. The circuitry 1200 consists of a general purpose microcontroller unit, MCU 1205 MCU, a touch screen controller 1201, tablet drive circuits 1202, a battery, 1203, flash memory 1204, a USB port IC 1206, and a blue tooth IC 1207. The touch screen data capture device 540 is integrated with writing/drawing surface 510 to form a combined writing and recording tablet 550 as illustrated in FIG. 1A. All writing and drawing on the drawing surface 510 is sense by the data capture device 540 and converted by the data capture controller 1201 into coordinate data which is then captured by the MCU 1205. Then the data from the MCU 1205 is sent by single data point, or group of data points, or one complete capture, through the USB port 1206 or blue tooth port 1207 to external device, such as PC, laptop, PDA or cell phone not shown in FIG. 11. The image on the writing tablet is erased by voltage pulses supplied to driving circuit 1202.

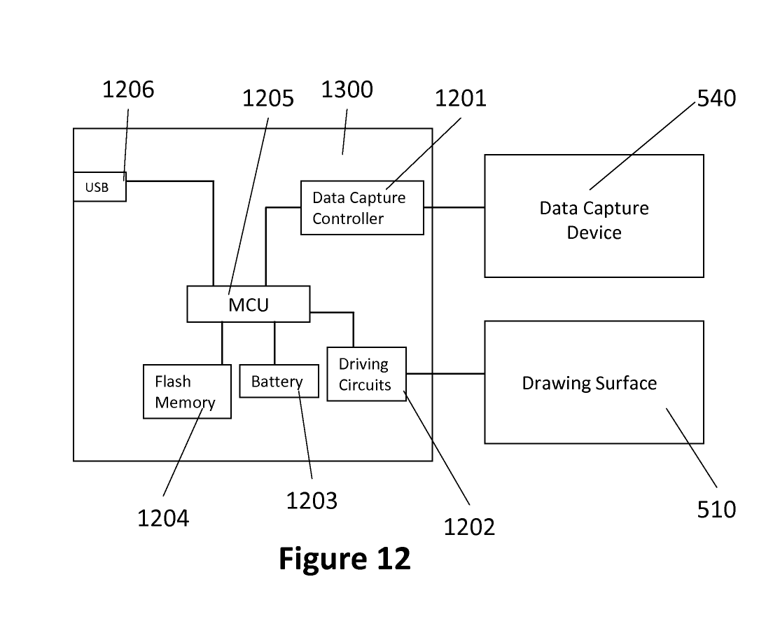

2. A Writing/Drawing Tablet with local memory: The general design of this example embodiment is shown in the block diagram in FIG. 12. It includes a writing/drawing surface 510, a touch screen data capture device 540 and associated circuitry 1300. Circuitry 1300 includes, a general purpose MCU 1205, a data capture controller 1201, tablet drive circuits 1202, a battery 1203, flash memory 1204, and an optional USB port 1206. The flash memory 1204 may be removable, such as by using a USB flash drive or other types of removable flash memory commonly used in the computer industry, such as compact flash, memory stick, MicroSD, MMC, etc. or an internal hard drive such as might be used in a laptop computer, for example. The touch screen 540 is integrated with writing/drawing tablet 510 to form a combined writing/recording tablet 550, as illustrated in FIG. 1A. All writing or drawing on the drawing surface 510 is sensed by data capture device 540 and converted by the touch screen controller 1201 into coordinate data and captured by the MCU 1205. Typically, whole images are captured and stored in the local flash memory 1204. The image files may then be transferred to external device, such as PC, laptop, PDA, or cell phone not show in FIG. 12 through the USB port 1206. This Flash memory 1204 may be removed (such as an SD Card) to transfer data to an external device. Such device might also function as a USB drive, for example.

Furthermore, the images stored in the memory might be replayed by the tablet through an external display, or a review/preview display integrated with the tablet. For example, a scroll button could be provided that will scroll through the stored images and redraw them on the external/preview display, without downloading the entire set of images.

Various additional features could be utilized for additional embodiments, such as:

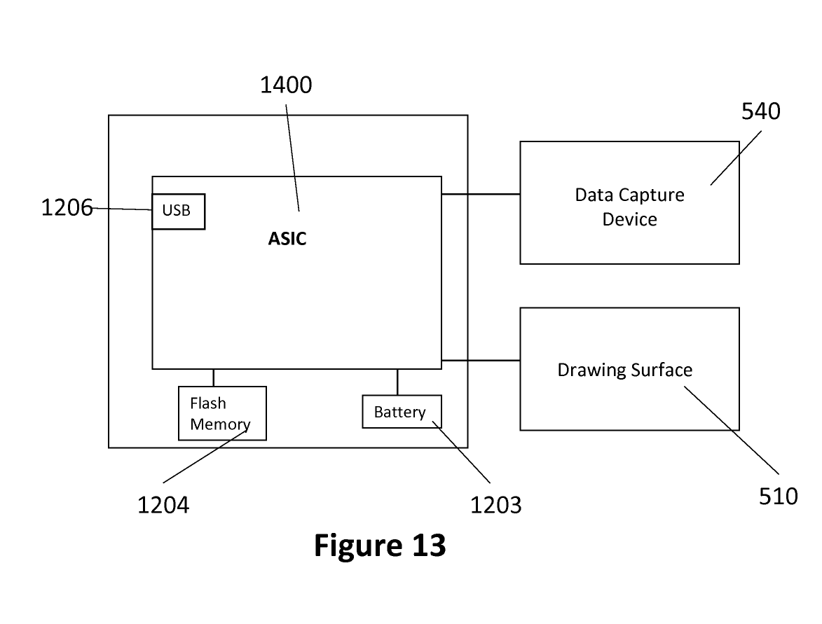

1. ASIC: To further reduce the cost and improve reliability, the MCU 1205, USB port 1206, touch screen controller 1201, and driving circuits 1202 can be replaced with one customized integrated circuit 1400 (ASIC), as illustrated in FIG. 13.

2. Rechargeable Battery: The battery 1203 in FIGS. 11′, 12, 13, and 14 in the design could utilize a rechargeable Li-Poly battery (or other rechargeable technology) and/or solar cell. The Li-Poly battery can be charged by a solar cell or by a USB port, for example. Such a design might last for years with out any changes or replacement parts. It is a true green design.

3. Resistive Touch Screen: Typical resistive touch screens are made with a flexible substrate and a glass substrate to support the touch action; however, in this application, a glass substrate is not necessary since the touch screen need not be transparent, and thus can be eliminated. The touch screen can be installed on the back of the writing/drawing tablets underneath the display layer(s) of the drawing surface, and the plastic housing at the bottom of the writing/drawing tablet can be utilized for support. Such design can also make the touch screen thin, light, and durable. Also in this example embodiment, the optical property of the touch screen does not matter, because the light need not travel through that layer. Other touch screen technologies that can be used underneath the tablet display layer, include an inductive touch screen. The inductive technology uses a special pen (stylus) with a resonant circuit to sense the pen position. A capacitive touch screen, in contrast, would in most cases need to be applied over the display layer, and thus would require consideration of its light transmissive properties for it to be utilized for the drawing tablet.

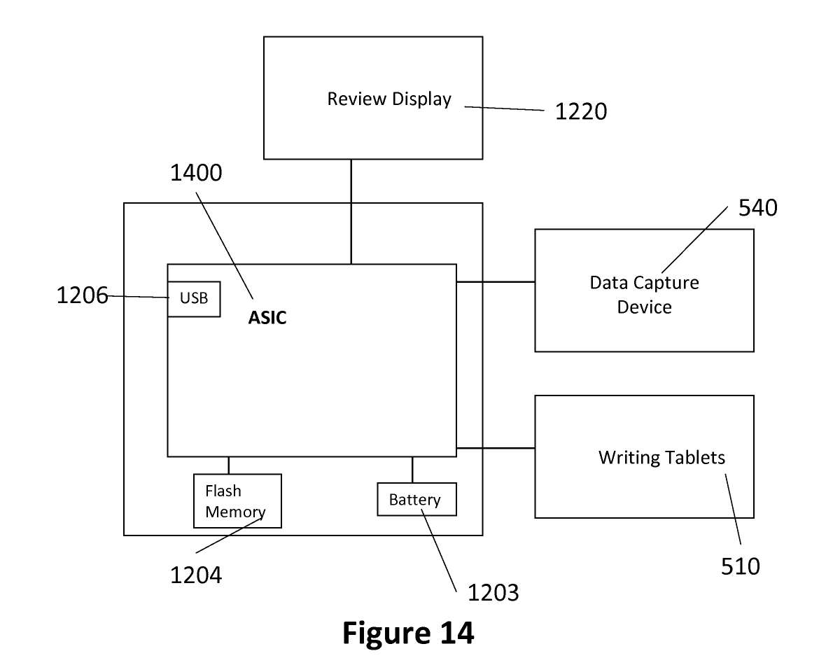

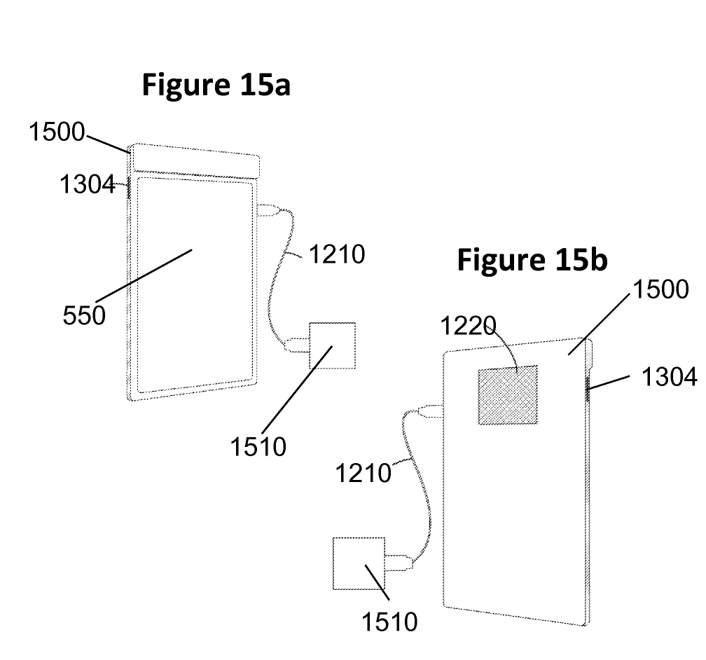

FIG. 15a shows an artistic illustration of an example of a commercially viable embodiment of the conceived device. The writing tablet drawing surface 550 is integrated with the touch screen and is encased in a housing 1500 which further contains the associated electronic circuitry such as, for example, illustrated in block diagram of FIG. 11 or block diagram of FIG. 12. The space required for the circuitry is considerably reduced by use of a suitable ASIC chip 1400 as diagramed in FIGS. 14 and 15, for example. An optional removable Flash memory slot 1304 for inserting removable flash memory may be used to transfer images to a PC or other device for viewing or the images may be transferred directly by a cable 1210 connecting the USB port of the recording tablet to an external device 1510 such as a PC or similar device with a display for viewing the image.

4. Small Format Display: A display 1220 can be added to the device, such as a small format display (such as 2.5″ TFT, for example), for page review/preview, such as is illustrated in FIGS. 14 and 15b. Such a display could also be used to scroll through the images stored in the tablet.

5. Button Interface: A simple user interface can be provided to allow for simple user functions. For example, a two or three actuator (such as pushbutton) design could be useful, with one actuator for activating the function of storing the image, and another actuator for erasing the image, and a third actuator for storing the image. Optionally, a single erase button could be utilized to store the data before erasing it. Or both the store and erase buttons might activate the same, or different, store functions. A scroll button may be provided, or one of the above actuators might be utilized for this purpose, such as by multiple activation of the actuator, or holding it down for a certain period of time, for example.

6. Negative Mode: A negative drawing mode can be implemented in a manner discussed in U.S. patent application Ser. No. 12/152,729 and incorporated herein by reference. In this mode, an image can be drawn using a stylus by applying a voltage V_{W} using a write circuit. Thus, in contrast to the normal modes discussed above, electrical power is utilized for this drawing mode. The voltage is applied for the duration of the stylus write; preferably, V_{W} is a continuous AC voltage or a sequence of bipolar pulses. The voltage is applied to patterned or unpatterned electrodes so that the entire display area of liquid crystal seen by the user of the writing tablet, has an electric field applied to it. The voltage V_{W} will drive that area of the cell to which it is applied to the focal conic texture; that is, areas of the cell under the stylus where pressure is applied and cell gap is reduced. The planar texture in that area is driven to the focal conic texture. In the remainder of the cell where the cell gap is not disturbed, even though the electric field has been applied here, the material will remain in the planar texture, leaving a planar background for the focal conic writing. In other words, the liquid crystal material where the cell gap is undisturbed remains in the planar texture while the voltage V_{W} is applied to the electrodes and is not converted to the focal conic texture. Power can be removed after the drawing operation, with the image being retained on the drawing surface.

Note also that the color drawing feature described in the cited application could also be utilized for a drawing tablet with data capture. Also, selective erasure of portions of the drawing also described in that application, could also be utilized for the tablet with data capture features.

### EXAMPLES OF TABLETS WITH DATA CAPTURE

### Example 1

### Recording Writing Tablet with a Resistive Touch Screen

Resistive touch screens are commonly used in such applications as cell phones and various other touch screen monitors. A resistive touch screen is fabricated with two transparent flexible substrates stacked on top of one another and separated with a gap of a few microns. The inner surface of each of the substrates is coated with a transparent conducting material, usually indium tin oxide, ITO. When pressure is applied to the upper substrate with a pointed stylus or finger the top substrate electrical contact is made between the upper and lower substrate at the point where pressure is applied. When voltage is applied across the conductor of one of the substrates, say the upper substrate, a voltage divider is created. The coordinates of the stylus can be found by applying a voltage across one substrate's conductor in the Y direction and reading the voltage created by the voltage divider from the other substrate's conductor to find the Y coordinate, and then applying a voltage across the other substrate's conductor in the X direction and reading the voltage created the voltage divider from the first substrate's conductor to find the X coordinate (see for example U.S. Pat. No. 6,178,048, incorporated by reference).

A prototype of a writing tablet information recording device was made by stacking a cholesteric pressure sensitive writing tablet on top of a resistive touch screen. The pressure sensitive writing screen used in the prototype was part number 1580001516B used in the Boogie Board™ writing tablet product of Improv Electronics, a company of Kent Displays, Inc., 343, Portage Blvd., Kent Ohio 44240. The resistive touch screen used was a 4-wire resistive touch screen, part number 400-429, of Bergquist Touch Products, 301 Washington Street, Cannon Falls Minn. 55009. With the active area (5″×7″) of the pressure sensitive writing screen being slightly smaller than that of the resistive touch screen (6″×8″), the cholesteric writing screen was held on top of the touch screen with tape around the edges of the writing screen. A four-wire resistive touch screen controller using a Texas Instruments MSP430F248 microcontroller was implemented following the Texas Instruments Application Report SLAA384—February 2008 by N Brenner and Sullivan as obtained under URL: http://focus.ti.com/lit/an/slaa384/slaa384.pdf (Texas Instruments, P.O. Box 655303, Dallas Tex. 75365).

With the output of the touch screen controller connected to a PC via a serial port, it was observed that writing an image on the pressure sensitive writing tablet with a pointed stylus would also trace the same image on the PC screen when running the PC application included in SLAA384. The image created on the PC screen could be saved using the ‘Print Screen’ functionality of the PC to copy the application window to the clipboard and then paste the window into a drawing application such as Paint, from where it could be saved for later recall.

### Example 2

### Recording Writing Table with Inductive Touch Screen

As described, for example, in U.S. Pat. No. 4,786,765 herein incorporated by reference, inductive touch screens consists of special stylus that includes the tuned circuit of an inductor and capacitor connected in series. The stylus is without connection to a power supply or other device but has a resonant frequency approximately equal to the frequency of a wave derived from a coil arrangement in a tablet. The position of the stylus on the tablet is detected by coupling energy induced in the stylus back to the tablet.

A prototype writing tablet information recording device was fabricated by stacking a cholesteric pressure sensitive writing tablet on top of an inductive touch screen module of Wacom Co. Ltd. The cholesteric pressure sensitive writing screen used in the prototype was part number 1580001516B used in the Boogie Board™ writing tablet product of Improv Electronics, a company of Kent Displays, Inc., 343, Portage Blvd., Kent Ohio 44240. The inductive touch screen used was part number SU5E-13WO1AS-01X of Wacom Co. Ltd., 2-510-1 Toyonodai, Otone-machi, Kitasaitama-gun, Saitama, 349-1148, JAPAN. As in Example 1, a Texas Instrument MSP430F248 microcontroller was used to interface between the touchscreen and a PC application which displayed the image drawn on the display. In this case the microcontroller interfaced to a Wacom touch controller included with the touchscreen which controlled the touch screen and provided touch coordinates. The cholesteric pressure sensitive writing screen was laid over the Wacom touch sensitive module and held in place with tape and alternatively with pressure. The MSP430 F248 microcontroller relayed touch coordinates from the touch screen to a PC application similar to that in SLAA384 via a serial port.

It was observed that with the stylus provided by Wacom with the inductive touch screen one could write an image on the cholesteric tablet while the image was being digitized, recorded and displayed on the PC simultaneously. An advantage of the inductive touch screen over the resistive touch screen of Example 1 was found in that the tablet only responded to the pressure of the stylus and not, for example, on the hand resting on the tablet.

### Example 3

### Cholesteric Writing Tablet Overlaying a Bamboo™ Pen Tablet

The concept of coupling a cholesteric writing tablet with a touch sensitive device to digitally record information was demonstrated by use of a commercial Bamboo™ Pen Tablet of Wacom Co. Ltd. A Bamboo™ Pen tablet is a device that works with a standard computer, laptop or desktop. Using the inductive touch screen technology described in Example 2, the Bamboo™ Pen functions as a tablet to display hand written information or drawings on the computer screen with the special inductive stylus. A problem with the device is that one cannot see the hand writings on the tablet device itself. Adding the cholesteric tablet to the Bamboo™ Pen Tablet corrects this problem. In order to demonstrate this feature, a cholesteric pressure sensitive writing screen, part number 1580001516B of Improv Electronics was overlaid on the Bamboo™ Tablet and held in place with pressure. It was demonstrated that writing an image on the cholesteric tablet would also create the same image on the computer screen.

Many other example embodiments of the invention can be provided through various combinations of the above described features. Although the invention has been described hereinabove using specific examples and embodiments, it will be understood by those skilled in the art that various alternatives may be used and equivalents may be substituted for elements and/or steps described herein, without necessarily deviating from the intended scope of the invention. Modifications may be necessary to adapt the invention to a particular situation or to particular needs without departing from the intended scope of the invention. It is intended that the invention not be limited to the particular implementations and embodiments described herein, but that the claims be given their broadest reasonable interpretation to cover all novel and non-obvious embodiments, literal or equivalent, disclosed or not, covered thereby.

What is claimed is:

1. A writing/drawing tablet device with data capture comprising:
a drawing surface integrated in the tablet and adapted to display back to the user a result of an image drawn or written upon said drawing surface by the user, and
a data capture device for capturing said image drawn or written upon said drawing surface for storing in a memory device, wherein
said display back to the user of the image drawn or written upon said drawing surface does not require the consumption of electrical power from any power source.

2. The tablet device of claim 1, wherein said drawing surface comprises an LCD for displaying back the image drawn or written on the drawing surface.

3. The tablet device of claim 2, wherein said LCD is a cholesteric LCD.

4. The tablet device of claim 1, wherein said drawing surface is a pressure sensitive drawing surface and wherein said image is drawn or written upon said drawing surface by applying pressure to said drawing surface.

5. The tablet device of claim 4, wherein said pressure is applied to said drawing surface using a stylus.

6. The tablet device of claim 4, wherein said data capture device is adapted to convert pressure points to electrical signals for capturing said image drawn or written upon said drawing surface into said memory device.

7. The tablet device of claim 4, wherein said data capture device comprises a touch screen device utilized for capturing said image drawn or written upon said drawing surface into said memory device.

8. The tablet device of claim 1, wherein said data capture device comprises an optical scanning device that is utilized for capturing said image drawn or written upon said drawing surface into said memory device.

9. The tablet device of claim 1, wherein said data capture device comprises a touch screen device utilized for capturing said image drawn or written upon said drawing surface into said memory device.

10. The tablet device of claim 1, wherein said memory device is a flash memory or RAM comprised in said tablet device.

11. The tablet device of claim 1, further comprising a data interface, wherein said memory device is included in an external device communicating with said tablet device utilizing said data interface for capturing said image.

12. The tablet device of claim 1, further comprising a data interface, wherein said memory device is included in an external device communicating with said tablet device utilizing said data interface for capturing said image, wherein said memory device is used to reproduce the image on a remote display included with said external device.

13. The tablet device according to claim 1, further comprising an additional display for displaying a replica of the image the captured in said memory device.

14. The tablet device of claim 13, wherein said table device is adapted such that additional images previously stored in said memory device can be displayed on said additional display when selected by the user for such display.

15. The tablet device according to claim 14, further comprising a rechargeable battery for providing power to said tablet device for powering said additional display.

16. The tablet device of claim 15, further comprising a solar cell for charging said rechargeable battery.

17. The tablet device according to claim 15, further comprising an erase actuator, such that activation of the erase actuator by the user erases the image drawn or written upon said drawing surface by application of a voltage to said drawing surface.

18. The tablet device according to claim 1, further comprising an erase actuator, such that activation of the erase actuator by the user erases at least a portion of the image drawn or written upon said drawing surface by application of a voltage to a corresponding portion of the drawing surface.

19. The tablet device according to claim 1 wherein said pressure sensitive data capture surface includes a resistive or inductive touchscreen.

20. The tablet device according to claim 1, further comprising a processor for processing the image captured by said data capture device prior to storing said image in the memory device.

21. The tablet device according to claim 1, wherein said memory device is included in said tablet.

22. The tablet device according to claim 21, further comprising a memory interface wherein said memory device communicates with said tablet via said memory interface and said memory device is removable from said tablet by a user.

23. A writing/drawing tablet device with data capture comprising:
a power supply for powering said device;
a memory storage device;
a pressure sensitive drawing surface integrated in said tablet device and adapted to display back to the user a result of an image drawn or written upon said drawing surface by application of pressure by the user, said display back to the user provided without said pressure sensitive drawing surface consuming electrical energy;
a switch for erasing said image from said drawing surface by providing electrical energy to said drawing surface when said switch is actuated by a user;
a data capture device for electronically capturing said image drawn or written upon said drawing surface into data for storing in a memory device; and
a data interface for connecting said tablet device to an external device for communicating with said tablet device for receiving said data.

24. The writing table according to claim 23, wherein a voltage is applied to at least a portion of said pressure sensitive drawing surface during said display back of the image to the user.

25. A writing/drawing tablet device with data capture comprising:
a pressure sensitive drawing surface including a first substrate having at least one liquid crystal layer and adapted to display back to the user a result of an image drawn or written upon said drawing surface by application of pressure by the user to said drawing surface to locally displace said liquid crystal to change its reflectance in a persistent manner;
a pressure sensitive data capture surface including a second substrate for converting said image drawn or written upon said drawing surface into data; and
a memory device for storing said data, wherein said data is used for reproducing said image drawn or written upon said drawing surface.

26. The tablet device according to claim 25 further comprising an additional display for displaying an image from said data.

27. The tablet device according to claim 25 wherein said pressure sensitive data capture surface includes a resistive or inductive touchscreen device.

28. The tablet device according to claim 25, further comprising a processor for processing the data captured by said data capture device prior to storing said data in the memory device.

29. A writing/drawing tablet device with data capture comprising:
a power supply for powering said device;
a memory storage device;
a pressure sensitive drawing surface including a first substrate having at least one liquid crystal layer and adapted to display back to the user a result of an image drawn or written upon said drawing surface by application of pressure by the user to said drawing surface to locally displace said liquid crystal to change its reflectance in a persistent manner without any substantial consumption of electrical power;
a switch for erasing said image from said drawing surface by providing electrical energy to said drawing surface when said switch is actuated by a user;
a data capture device for electronically capturing said image drawn or written upon said drawing surface into data for storing in a memory device; and
a data interface for connecting said tablet device to an external device for communicating with said tablet device for receiving said data.

30. A method of generating and reproducing an image on a display device, said method comprising the steps of:
changing a reflectance of a portion of a chemical layer integrated in a drawing surface of said display device in response to a pressure being applied to the portion of the chemical layer for presenting an image on said drawing surface;
converting said image on said drawing surface to data by also utilizing said applied pressure;
storing said data in a memory device connected to said display device; and
reproducing said image on a display different than said drawing surface.

31. The method of claim 30, wherein said presenting an image on said drawing surface does not require application of electrical power.

32. The method of claim 30, wherein said image is reproduced on the display different than said drawing surface by utilizing said data stored in the memory device.

33. The method of claim 30, wherein said chemical layer includes a cholesteric liquid crystal material
